(19) United States
(12) Patent Application Publication
(10) Pub. No.: US 2024/0202981 A1
(43) Pub. Date: Jun. 20, 2024

(54) Motion Compensation Based Neighborhood Configuration for TriSoup Vertex Information

(71) Applicant: Comcast Cable Communications, LLC, Philadelphia, PA (US)

(72) Inventor: Sébastien Lasserre, Thorigné-Fouillard (FR)

(21) Appl. No.: 18/390,997

(22) Filed: Dec. 20, 2023

Related U.S. Application Data
(60) Provisional application No. 63/433,884, filed on Dec. 20, 2022.

(51) Int. Cl. G06T 9/00

(52) U.S. Cl. CPC G06T 9/001

(57) ABSTRACT

An encoder and/or a decoder may code visual data, based on a motion compensated point cloud. For example, the encoder and/or the decoder may determine one or more symbols of a neighborhood configuration of a current edge based at least on the motion compensated point cloud. The encoder and/or the decoder may code (e.g., arithmetic code) vertex information of the current edge based on a context (or probability model). The context (or probability model) may be selected using, for example, a look up table, based on the neighborhood configuration. The neighborhood configuration may be a reduced configuration that may represent a subset of symbols of a whole neighborhood configuration.

### CROSS-REFERENCE TO RELATED APPLICATIONS

This application claims the benefit of U.S. Provisional Application No. 63/433,884 filed on Dec. 20, 2022. The above referenced application is hereby incorporated by reference in its entirety.

### BACKGROUND

An object or scene may be described using volumetric visual data consisting of a series of points. The points may be stored as a point cloud format that includes a collection of points in three-dimensional space. As point clouds can get quite large in data size, transmitting and processing point cloud data may need a data compression scheme that is specifically designed with respect to the unique characteristics of point cloud data.

### SUMMARY

The following summary presents a simplified summary of certain features. The summary is not an extensive overview and is not intended to identify key or critical elements.

Coding (e.g., encoding, decoding) may be used to compress and decompress a point cloud frame or sequence for efficient storage and transmission. An encoder and/or a decoder may code visual data, based on a motion compensated point cloud. For example, the encoder and/or the decoder may determine one or more symbols of a neighborhood configuration of a current edge based at least on the motion compensated point cloud. The encoder and/or the decoder may entropy code (e.g., arithmetic code) vertex information of the current edge based on a context (or a probability model). The context (or a probability model) may be selected using, for example, a look up table, based on the neighborhood configuration. The neighborhood configuration may be a reduced configuration that may represent a subset of symbols of a whole neighborhood configuration. For example, compensated TriSoup vertices may be determined for a current edge and neighboring edges, for example, based on points of a motion compensated point cloud neighboring the edge. For example, a plurality of planes may be used for the reduction. The use of a motion compensated point cloud may add inter frame correlation and/or improve compression/decompression of the visual data.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIG. 1 shows an example point cloud coding system.

FIG. 2 shows an example Morton order.

FIG. 3 shows an example scanning order.

FIG. 4 shows an example neighborhood of cuboids with already-coded occupancy bits.

FIG. 5 shows an example of a dynamic reduction function DR that may be used in dynamic Optimal Binary Coders with Update on the Fly (OBUF).

FIG. 6 shows an example method for coding occupancy of a cuboid using dynamic OBUF.

FIG. 7 shows an example of an occupied cuboid.

FIG. 8(a) shows an example cuboid corresponding to a TriSoup node.

FIG. 8(b) shows an example refinement to the TriSoup model.

FIG. 9 shows an example of voxelization.

FIG. 10(a) and FIG. 10(b) show example cuboids.

FIG. 11(a), FIG. 11(b), and FIG. 11(c) show TriSoup edges that may be used to entropy code a current TriSoup edge.

FIG. 12 shows an example encoding method.

FIG. 13(a), FIG. 13(b), and FIG. 13(c) show example types of neighborhood information.

FIG. 14(a) and FIG. 14(b) show example point locations of a point cloud that neighbor a current edge E of a TriSoup node.

FIG. 15(a) and FIG. 15(b) show example occupancies of point neighborhoods in a motion compensated point cloud.

FIG. 16 shows an example of a reduction that may be applied to a point neighborhood.

FIG. 17(a) and FIG. 17(b) show another example of a reduction that may be applied to a point neighborhood.

FIG. 18(a) shows an example compensated TriSoup vertex belonging to an edge.

FIG. 18(b) and FIG. 18(c) show quantization functions of the position of the compensated TriSoup vertex belonging to the edge.

FIG. 19(a) shows an example method for encoding vertex information of a current edge.

FIG. 19(b) shows an example method for decoding vertex information of a current edge.

FIG. 20 shows an example computer system that may be used by any of the examples described herein.

FIG. 21 shows example elements of a computing device that may be used to implement any of the various devices described herein.

### DETAILED DESCRIPTION

The accompanying drawings and descriptions provide examples. It is to be understood that the examples shown in the drawings and/or described are non-exclusive, and that features shown and described may be practiced in other examples. Examples are provided for operation of point cloud or point cloud sequence encoding or decoding systems. More particularly, the technology disclosed herein may relate to point cloud compression as used in encoding and/or decoding devices and/or systems.

At least some visual data may describe an object or scene using a series of points. Each point may comprise a position in two dimensions (x and y) and one or more optional attributes like color. Volumetric visual data may add another positional dimension to these visual data. For example, volumetric visual data may describe an object or scene using a series of points that each may comprise a position in three dimensions (x, y, and z) and one or more optional attributes like color, reflectance, time stamp, etc. Volumetric visual data may provide a more immersive way to experience visual data, for example, compared to the at least some visual data. For example, an object or scene described by volumetric visual data may be viewed from any (or multiple) angles, whereas the at least some visual data may generally only be viewed from the angle in which it was captured or rendered.

Volumetric visual data may be used in many applications, including augmented reality (AR), virtual reality (VR), and mixed reality (MR). Sparse volumetric visual data may be used in the automotive industry for the representation of three-dimensional (3D) maps (e.g., cartography) or as input to assisted driving systems. In the case of assisted driving systems, volumetric visual data may be typically input to driving decision algorithms. Volumetric visual data may be used to store valuable objects in digital form. In applications for preserving cultural heritage, a goal may be to keep a representation of objects that may be threatened by natural disasters. For example, statues, vases, and temples may be entirely scanned and stored as volumetric visual data having several billions of samples. This use-case for volumetric visual data may be particularly relevant for valuable objects in locations where earthquakes, tsunamis and typhoons are frequent. Volumetric visual data may take the form of a volumetric frame. The volumetric frame may describe an object or scene captured at a particular time instance. Volumetric visual data may take the form of a sequence of volumetric frames (referred to as a volumetric sequence or volumetric video). The sequence of volumetric frames may describe an object or scene captured at multiple different time instances.

Volumetric visual data may be stored in various formats. One format for storing volumetric visual data may be point clouds. A point cloud may comprise a collection of points in 3D space. Each point in a point cloud may comprise geometry information that may indicate the point's position in 3D space. For example, the geometry information may indicate the point's position in 3D space, for example, using three Cartesian coordinates (x, y, and z) and/or using spherical coordinates (r, phi, theta) (e.g., if acquired by a rotating sensor). The positions of points in a point cloud may be quantized according to a space precision. The space precision may be the same or different in each dimension. The quantization process may create a grid in 3D space. One or more points residing within each sub-grid volume may be mapped to the sub-grid center coordinates, referred to as voxels. A voxel may be considered as a 3D extension of pixels corresponding to the 2D image grid coordinates. A point in a point cloud may comprise one or more types of attribute information. Attribute information may indicate a property of a point's visual appearance. For example, attribute information may indicate a texture (e.g., color) of the point, a material type of the point, transparency information of the point, reflectance information of the point, a normal vector to a surface of the point, a velocity at the point, an acceleration at the point, a time stamp indicating when the point was captured, or a modality indicating how the point was captured (e.g., running, walking, or flying). A point in a point cloud may comprise light field data in the form of multiple view-dependent texture information. Light field data may be another type of optional attribute information.

The points in a point cloud may describe an object or a scene. For example, the points in a point cloud may describe the external surface and/or the internal structure of an object or scene. The object or scene may be synthetically generated by a computer. The object or scene may be generated from the capture of a real-world object or scene. The geometry information of a real-world object or a scene may be obtained by 3D scanning and/or photogrammetry. 3D scanning may include different types of scanning, for example, laser scanning, structured light scanning, and/or modulated light scanning. 3D scanning may obtain geometry information. 3D scanning may obtain geometry information, for example, by moving one or more laser heads, structured light cameras, and/or modulated light cameras relative to an object or scene being scanned. Photogrammetry may obtain geometry information. Photogrammetry may obtain geometry information, for example, by triangulating the same feature or point in different spatially shifted 2D photographs. Point cloud data may take the form of a point cloud frame. The point cloud frame may describe an object or scene captured at a particular time instance. Point cloud data may take the form of a sequence of point cloud frames. The sequence of point cloud frames may be referred to as a point cloud sequence or point cloud video. The sequence of point cloud frames may describe an object or scene captured at multiple different time instances.

The data size of a point cloud frame or point cloud sequence may be excessive (e.g., too large) for storage and/or transmission in many applications. For example, a single point cloud may comprise over a million points or even billions of points. Each point may comprise geometry information and one or more optional types of attribute information. The geometry information of each point may comprise three Cartesian coordinates (x, y, and z) and/or spherical coordinates (r, phi, theta) that may be each represented, for example, using at least 10 bits per component or 30 bits in total. The attribute information of each point may comprise a texture corresponding to a plurality of (e.g., three) color components (e.g., R, G, and B color components). Each color component may be represented, for example, using 8-10 bits per component or 24-30 bits in total. For example, a single point may comprise at least 54 bits of information, with at least 30 bits of geometry information and at least 24 bits of texture. If a point cloud frame includes a million such points, each point cloud frame may require 54 million bits or 54 megabits to represent. For dynamic point clouds that change over time, at a frame rate of 30 frames per second, a data rate of 1.32 gigabits per second may be required to send (e.g., transmit) the points of the point cloud sequence. Raw representations of point clouds may require a large amount of data, and the practical deployment of point-cloud-based technologies may need compression technologies that enable the storage and distribution of point clouds with a reasonable cost.

Encoding may be used to compress and/or reduce the data size of a point cloud frame or point cloud sequence to provide for more efficient storage and/or transmission. Decoding may be used to decompress a compressed point cloud frame or point cloud sequence for display and/or other forms of consumption (e.g., by a machine learning based device, neural network-based device, artificial intelligence-based device, or other forms of consumption by other types of machine-based processing algorithms and/or devices). Compression of point clouds may be lossy (introducing differences relative to the original data) for the distribution to and visualization by an end-user, for example, on AR or VR glasses or any other 3D-capable device. Lossy compression may allow for a high ratio of compression but may imply a trade-off between compression and visual quality perceived by an end-user. Other frameworks, for example, frameworks for medical applications or autonomous driving, may require lossless compression to avoid altering the results of a decision obtained, for example, based on the analysis of the sent (e.g., transmitted) and decompressed point cloud frame.

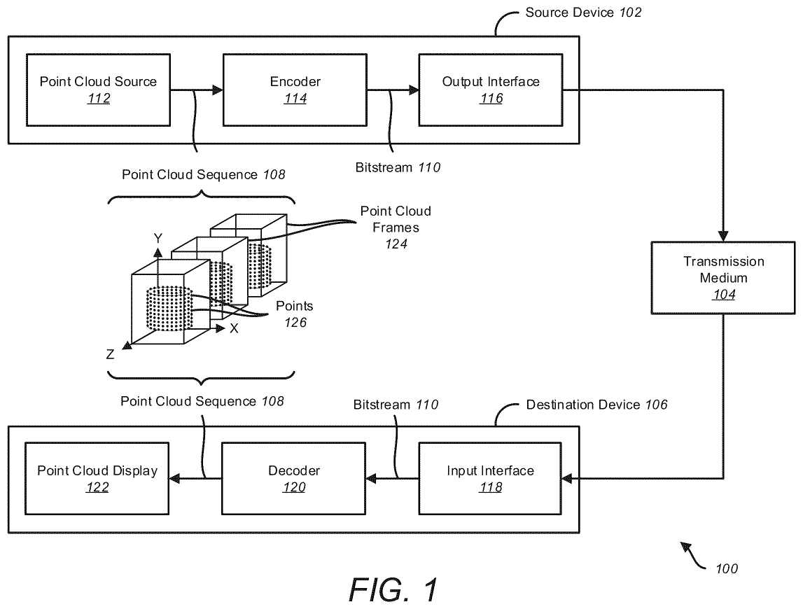

FIG. 1 shows an example point cloud coding (e.g., encoding and/or decoding) system 100. Point cloud coding system 100 may comprise a source device 102, a transmission medium 104, and a destination device 106. Source device 102 may encode a point cloud sequence 108 into a bitstream 110 for more efficient storage and/or transmission. Source device 102 may store and/or send (e.g., transmit) bitstream 110 to destination device 106 via transmission medium 104. Destination device 106 may decode bitstream 110 to display point cloud sequence 108 or for other forms of consumption (e.g., further analysis, storage, etc.). Destination device 106 may receive bitstream 110 from source device 102 via a storage medium or transmission medium 104. Source device 102 and destination device 106 may include any number of different devices. Source device 102 and destination device 106 may include, for example, a cluster of interconnected computer systems acting as a pool of seamless resources (also referred to as a cloud of computers or cloud computer), a server, a desktop computer, a laptop computer, a tablet computer, a smart phone, a wearable device, a television, a camera, a video gaming console, a set-top box, a video streaming device, a vehicle (e.g., an autonomous vehicle), or a head-mounted display. A head-mounted display may allow a user to view a VR, AR, or MR scene and adjust the view of the scene, for example, based on movement of the user's head. A head-mounted display may be connected (e.g., tethered) to a processing device (e.g., a server, a desktop computer, a set-top box, or a video gaming console) or may be fully self-contained.

A source device 102 may comprise a point cloud source 112, an encoder 114, and an output interface 116. A source device 102 may comprise a point cloud source 112, an encoder 114, and an output interface 116, for example, to encode point cloud sequence 108 into a bitstream 110. Point cloud source 112 may provide (e.g., generate) point cloud sequence 108, for example, from a capture of a natural scene and/or a synthetically generated scene. A synthetically generated scene may be a scene comprising computer generated graphics. Point cloud source 112 may comprise one or more point cloud capture devices, a point cloud archive comprising previously captured natural scenes and/or synthetically generated scenes, a point cloud feed interface to receive captured natural scenes and/or synthetically generated scenes from a point cloud content provider, and/or a processor(s) to generate synthetic point cloud scenes. The point cloud capture devices may include, for example, one or more laser scanning devices, structured light scanning devices, modulated light scanning devices, and/or passive scanning devices.

Point cloud sequence 108 may comprise a series of point cloud frames 124 (e.g., an example shown in FIG. 1). A point cloud frame may describe an object or scene captured at a particular time instance. Point cloud sequence 108 may achieve the impression of motion by using a constant or variable time to successively present point cloud frames 124 of point cloud sequence 108. A point cloud frame may comprise a collection of points (e.g., voxels) 126 in 3D space. Each point 126 may comprise geometry information that may indicate the point's position in 3D space. The geometry information may indicate, for example, the point's position in 3D space using three Cartesian coordinates (x, y, and z). One or more of points 126 may comprise one or more types of attribute information. Attribute information may indicate a property of a point's visual appearance. For example, attribute information may indicate, for example, a texture (e.g., color) of a point, a material type of a point, transparency information of a point, reflectance information of a point, a normal vector to a surface of a point, a velocity at a point, an acceleration at a point, a time stamp indicating when a point was captured, a modality indicating how a point was captured (e.g., running, walking, or flying), etc. One or more of points 126 may comprise, for example, light field data in the form of multiple view-dependent texture information. Light field data may be another type of optional attribute information. Color attribute information of one or more of points 126 may comprise a luminance value and two chrominance values. The luminance value may represent the brightness (e.g., luma component, Y) of the point. The chrominance values may respectively represent the blue and red components of the point (e.g., chroma components, Cb and Cr) separate from the brightness. Other color attribute values may be represented, for example, based on different color schemes (e.g., an RBG or monochrome color scheme).

Encoder 114 may encode point cloud sequence 108 into a bitstream 110. To encode point cloud sequence 108, encoder 114 may use one or more lossless or lossy compression techniques to reduce redundant information in point cloud sequence 108. To encode point cloud sequence 108, encoder 114 may use one or more prediction techniques to reduce redundant information in point cloud sequence 108. Redundant information is information that may be predicted at a decoder 120 and may not be needed to be sent (e.g., transmitted) to decoder 120 for accurate decoding of point cloud sequence 108. For example, Motion Picture Expert Group (MPEG) introduced a geometry-based point cloud compression (G-PCC) standard (ISO/IEC standard 23090-9: Geometry-based point cloud compression). G-PCC specifies the encoded bitstream syntax and semantics for transmission and/or storage of a compressed point cloud frame and the decoder operation for reconstructing the compressed point cloud frame from the bitstream. During standardization of G-PCC, a reference software (ISO/IEC standard 23090-21: Reference Software for G-PCC) was developed to encode the geometry and attribute information of a point cloud frame. To encode geometry information of a point cloud frame, the G-PCC reference software encoder may perform voxelization. The G-PCC reference software encoder may perform voxelization, for example, by quantizing positions of points in a point cloud. Quantizing positions of points in a point cloud may create a grid in 3D space. The G-PCC reference software encoder may map the points to the center coordinates of the sub-grid volume (e.g., voxel) that their quantized locations reside in. The G-PCC reference software encoder may perform geometry analysis using an occupancy tree to compress the geometry information. The G-PCC reference software encoder may entropy encode the result of the geometry analysis to further compress the geometry information. To encode attribute information of a point cloud, the G-PCC reference software encoder may use a transform tool, such as Region Adaptive Hierarchical Transform (RAHT), the Predicting Transform, and/or the Lifting Transform. The Lifting Transform may be built on top of the Predicting Transform. The Lifting Transform may include an extra update/lifting step. The Lifting Transform and the Predicting Transform may be referred to as Predicting/Lifting Transform or pred lift. Encoder 114 may operate in a same or similar manner to an encoder provided by the G-PCC reference software.

Output interface 116 may be configured to write and/or store bitstream 110 onto transmission medium 104. The bitstream 110 may be sent (e.g., transmitted) to destination device 106. In addition or alternatively, output interface 116 may be configured to send (e.g., transmit), upload, and/or stream bitstream 110 to destination device 106 via transmission medium 104. Output interface 116 may comprise a wired and/or wireless transmitter configured to send (e.g., transmit), upload, and/or stream bitstream 110 according to one or more proprietary, open-source, and/or standardized communication protocols. The one or more proprietary, open-source, and/or standardized communication protocols may include, for example, Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, Wireless Application Protocol (WAP) standards, and/or any other communication protocol.

Transmission medium 104 may comprise a wireless, wired, and/or computer readable medium. For example, transmission medium 104 may comprise one or more wires, cables, air interfaces, optical discs, flash memory, and/or magnetic memory. In addition or alternatively, transmission medium 104 may comprise one or more networks (e.g., the Internet) or file server(s) configured to store and/or send (e.g., transmit) encoded video data.

Destination device 106 may decode bitstream 110 into point cloud sequence 108 for display or other forms of consumption. Destination device 106 may comprise one or more of an input interface 118, a decoder 120, and/or a point cloud display 122. Input interface 118 may be configured to read bitstream 110 stored on transmission medium 104. Bitstream 110 may be stored on transmission medium 104 by source device 102. In addition or alternatively, input interface 118 may be configured to receive, download, and/or stream bitstream 110 from source device 102 via transmission medium 104. Input interface 118 may comprise a wired and/or wireless receiver configured to receive, download, and/or stream bitstream 110 according to one or more proprietary, open-source, standardized communication protocols, and/or any other communication protocol. Examples of the protocols include Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, and Wireless Application Protocol (WAP) standards.

Decoder 120 may decode point cloud sequence 108 from encoded bitstream 110. For example, decoder 120 may operate in a same or similar manner as a decoder provided by G-PCC reference software. Decoder 120 may decode a point cloud sequence that approximates a point cloud sequence 108. Decoder 120 may decode a point cloud sequence that approximates a point cloud sequence 108 due to, for example, lossy compression of the point cloud sequence 108 by encoder 114 and/or errors introduced into encoded bitstream 110, for example, if transmission to destination device 106 occurs.

Point cloud display 122 may display a point cloud sequence 108 to a user. The point cloud display 122 may comprise, for example, a cathode rate tube (CRT) display, a liquid crystal display (LCD), a plasma display, a light emitting diode (LED) display, a 3D display, a holographic display, a head-mounted display, or any other display device suitable for displaying point cloud sequence 108.

Point cloud coding (e.g., encoding/decoding) system 100 is presented by way of example and not limitation. Point cloud coding systems different from the point cloud coding system 100 and/or modified versions of the point cloud coding system 100 may perform the methods and processes as described herein. For example, the point cloud coding system 100 may comprise other components and/or arrangements. Point cloud source 112 may, for example, be external to source device 102. Point cloud display device 122 may, for example, be external to destination device 106 or omitted altogether (e.g., if point cloud sequence 108 is intended for consumption by a machine and/or storage device). Source device 102 may further comprise, for example, a point cloud decoder. Destination device 106 may comprise, for example, a point cloud encoder. For example, source device 102 may be configured to further receive an encoded bit stream from destination device 106. Receiving an encoded bit stream from destination device 106 may support two-way point cloud transmission between the devices.

As described herein, an encoder may quantize the positions of points in a point cloud according to a space precision, which may be the same or different in each dimension of the points. The quantization process may create a grid in 3D space. The encoder may map any points residing within each sub-grid volume to the sub-grid center coordinates, referred to as a voxel. A voxel may be considered as a 3D extension of pixels corresponding to 2D image grid coordinates.

An encoder may represent or code a voxelized point cloud. An encoder may represent or code a voxelized point cloud, for example, using an occupancy tree. For example, the encoder may split the initial volume or cuboid containing the voxelized point cloud into sub-cuboids. The initial volume or cuboid may be referred to as a bounding box. A cuboid may be, for example, a cube. The encoder may recursively split each sub-cuboid that contains at least one point of the point cloud. The encoder may not further split sub-cuboids that do not contain at least one point of the point cloud. A sub-cuboid that contains at least one point of the point cloud may be referred to as an occupied sub-cuboid. A sub-cuboid that does not contain at least one point of the point cloud may be referred to as an unoccupied sub-cuboid. The encoder may split an occupied sub-cuboid into, for example, two sub-cuboids (to form a binary tree), four sub-cuboids (to form a quadtree), or eight sub-cuboids (to form an octrec). The encoder may split an occupied sub-cuboid to obtain further sub-cuboids. The sub-cuboids may have the same size and shape at a given depth level of the occupancy tree. The sub-cuboids may have the same size and shape at a given depth level of the occupancy trec, for example, if the encoder splits the occupied sub-cuboid along a plane passing through the middle of edges of the sub-cuboid.

The initial volume or cuboid containing the voxelized point cloud may correspond to the root node of the occupancy trec. Each occupied sub-cuboid, split from the initial volume, may correspond to a node (of the root node) in a second level of the occupancy tree. Each occupied sub-cuboid, split from an occupied sub-cuboid in the second level, may correspond to a node (off the occupied sub-cuboid in the second level from which it was split) in a third level of the occupancy tree. The occupancy tree structure may continue to form in this manner for each recursive split iteration until, for example, some maximum depth level of the occupancy tree is reached or each occupied sub-cuboid has a volume corresponding to one voxel.

Each non-leaf node of the occupancy tree may comprise or be associated with an occupancy word representing the occupancy state of the cuboid corresponding to the node. For example, a node of the occupancy tree corresponding to a cuboid that is split into 8 sub-cuboids may comprise or be associated with a 1-byte occupancy word. Each bit (referred to as an occupancy bit) of the 1-byte occupancy word may represent or indicate the occupancy of a different one of the eight sub-cuboids. Occupied sub-cuboids may be each represented or indicated by a binary “1” in the 1-byte occupancy word. Unoccupied sub-cuboids may be each represented or indicated by a binary “0” in the 1-byte occupancy word. Occupied and un-occupied sub-cuboids may be represented or indicated by opposite 1-bit binary values (e.g., a binary “0” representing or indicating an occupied sub-cuboid and a binary “1” representing or indicating an unoccupied sub-cuboid) in the 1-byte occupancy word.

Each bit of an occupancy word may represent or indicate the occupancy of a different one of the eight sub-cuboids. Each bit of an occupancy word may represent or indicate the occupancy of a different one of the eight sub-cuboids, for example, following the so-called Morton order. For example, the least significant bit of an occupancy word may represent or indicate, for example, the occupancy of a first one of the eight sub-cuboids following the Morton order. The second least significant bit of an occupancy word may represent or indicate, for example, the occupancy of a second one of the eight sub-cuboids following the Morton order, etc.

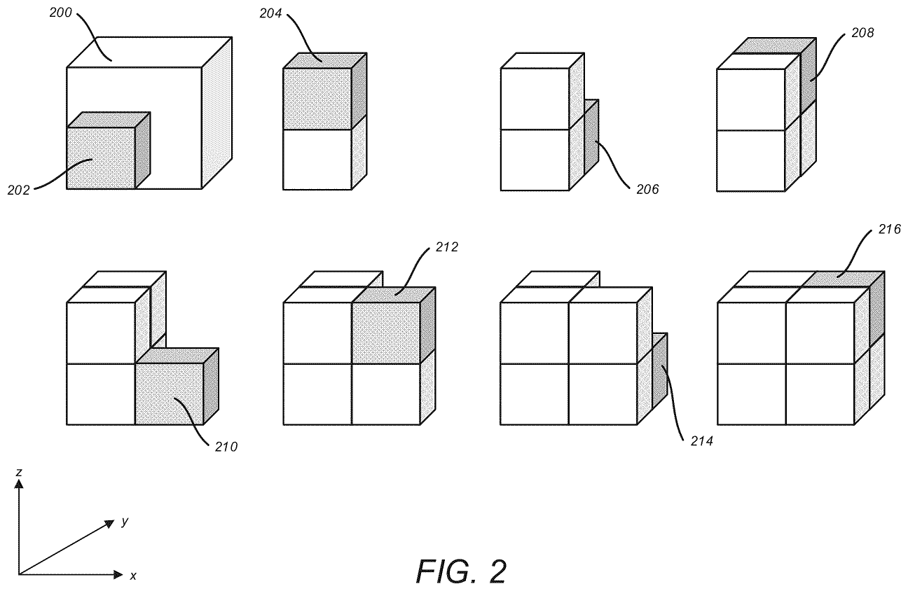

FIG. 2 shows an example Morton order. More specifically, FIG. 2 shows a Morton order of eight sub-cuboids 202-216 split from a cuboid 200. Sub-cuboids 202-216 may be labeled, for example, based on their Morton order, with child node 202 being the first in Morton order and child node 216 being the last in Morton order. The Morton order for sub-cuboids 202-216 may be a local lexicographic order in xyz.

The geometry of a voxelized point cloud may be represented by, and may be determined from, the initial volume and the occupancy words of the nodes in an occupancy trec. An encoder may send (e.g., transmit) the initial volume and the occupancy words of the nodes in the occupancy tree in a bitstream to a decoder for reconstructing the point cloud. The encoder may entropy encode the occupancy words. The encoder may entropy encode the occupancy words, for example, before sending (e.g., transmitting) the initial volume and the occupancy words of the nodes in the occupancy tree. The encoder may encode an occupancy bit of an occupancy word of a node corresponding to a cuboid. The encoder may encode an occupancy bit of an occupancy word of a node corresponding to a cuboid, for example, based on one or more occupancy bits of occupancy words of other nodes corresponding to cuboids that are adjacent or spatially close to the cuboid of the occupancy bit being encoded.

An encoder and/or a decoder may code (e.g., encode and/or decode) occupancy bits of occupancy words in sequence of a scan order. The scan order may also be referred to as a scanning order. For example, an encoder and/or a decoder may scan an occupancy tree in breadth-first order. All the occupancy words of the nodes of a given depth (e.g., level) within the occupancy tree may be scanned. All the occupancy words of the nodes of a given depth (e.g., level) within the occupancy tree may be scanned, for example, before scanning the occupancy words of the nodes of the next depth (e.g., level). Within a given depth, the encoder and/or decoder may scan the occupancy words of nodes in the Morton order. Within a given node, the encoder and/or decoder may scan the occupancy bits of the occupancy word of the node further in the Morton order.

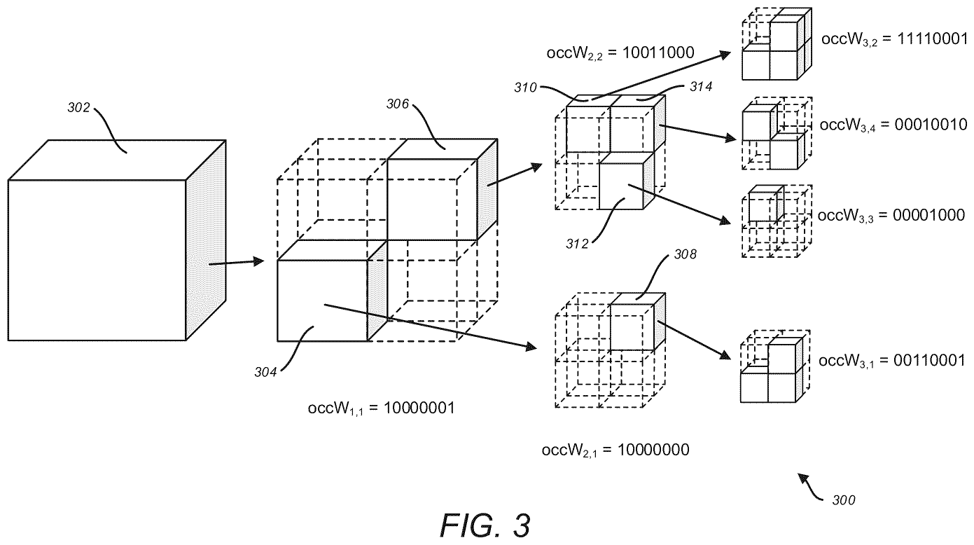

FIG. 3 shows an example scanning order. FIG. 3 shows an example scanning order (e.g., breadth-first order as described herein) for an occupancy tree 300. More specifically, FIG. 3 shows a scanning order for the first three example levels of an occupancy tree 300. In FIG. 3, a cuboid (e.g., cube) 302 corresponding to a root node of the occupancy tree 300 may be divided into eight sub-cuboids (e.g., sub-cubes). Two sub-cuboids 304 and 306 of the eight sub-cuboids may be occupied. The other six sub-cuboids of the eight sub-cuboids may be unoccupied. Following the Morton order, a first eight-bit occupancy word (e.g., occW_{1.1}) may be constructed to represent the occupancy word of the root node. An (e.g., each) occupancy bit of the first eight-bit occupancy word (e.g., occW_{1.1}) may represent or indicate the occupancy of a sub-cube of the eight sub-cuboids in the Morton order. For example, the least significant occupancy bit of the first eight-bit occupancy word occW_{1.1} may represent or indicate the occupancy of the first sub-cuboid of the eight sub-cuboids in the Morton order. The second least significant occupancy bit of the first eight-bit occupancy word occW_{1.1} may represent or indicate the occupancy of the second sub-cuboid of the eight sub-cuboids in the Morton order, etc.

Each of occupied sub-cuboids (e.g., two occupied sub-cuboids 304 and 306) may correspond to a node off the root node in a second level of an occupancy tree 300. The occupied sub-cuboids (e.g., two occupied sub-cuboids 304 and 306) may be each further split into eight sub-cuboids. For example, one of the sub-cuboids 308 of the eight sub-cuboids split from the sub-cube 304 may be occupied, and the other seven sub-cuboids may be unoccupied. Three of the sub-cuboids 310, 312, and 314 of the eight sub-cuboids split from the sub-cube 306 may be occupied, and the other five sub-cuboids of the eight sub-cuboids split from the sub-cube 306 may be unoccupied. Two second eight-bit occupancy words occW_{2.1} and occW_{2.2} may be constructed in this order to respectively represent the occupancy word of the node corresponding to the sub-cuboid 304 and the occupancy word of the node corresponding to the sub-cuboid 306.

Each of occupied sub-cuboids (e.g., four occupied sub-cuboids 308, 310, 312, and 314) may correspond to a node in a third level of an occupancy tree 300. The occupied sub-cuboids (e.g., four occupied sub-cuboids 308, 310, 312, and 314) may be each further split into eight sub-cuboids or 32 sub-cuboids in total. For example, four third level eight-bit occupancy words occW_{3.1}, occW_{3.2}, occW_{3.3} and occW_{3.4} may be constructed in this order to respectively represent the occupancy word of the node corresponding to the sub-cuboid 308, the occupancy word of the node corresponding to the sub-cuboid 310, the occupancy word of the node corresponding to the sub-cuboid 312, and the occupancy word of the node corresponding to the sub-cuboid 314.

Occupancy words of an example occupancy trec 300 may be entropy coded (e.g., entropy encoded by an encoder and/or entropy decoded by a decoder), for example, following the scanning order discussed herein (e.g., Morton order). The occupancy words of the example occupancy tree 300 may be entropy coded (e.g., entropy encoded by an encoder and/or entropy decoded by a decoder) as the succession of the seven occupancy words occW_{1.1} to occW_{3.4}, for example, following the scanning order discussed herein. The scanning order discussed herein may be a breadth-first scanning order. The occupancy word(s) of all node(s) having the same depth (or level) as a current parent node may have already been entropy coded, for example, if the occupancy word of a current child node belonging to the current parent node is being entropy coded. For example, the occupancy word(s) of all node(s) having the same depth (e.g., level) as the current child node and having a lower Morton order than the current child node may have also already been entropy coded. Part of the already coded occupancy word(s) may be used to entropy code the occupancy word of the current child node. The already coded occupancy word(s) of neighboring parent and child node(s) may be used, for example, to entropy code the occupancy word of the current child node. The occupancy bit(s) of the occupancy word having a lower Morton order than a particular occupancy bit may have also already been entropy coded and may be used to code the occupancy bit of the occupancy word of the current child node, for example, if the particular occupancy bit of the occupancy word of the current child node is being coded (e.g., entropy coded).

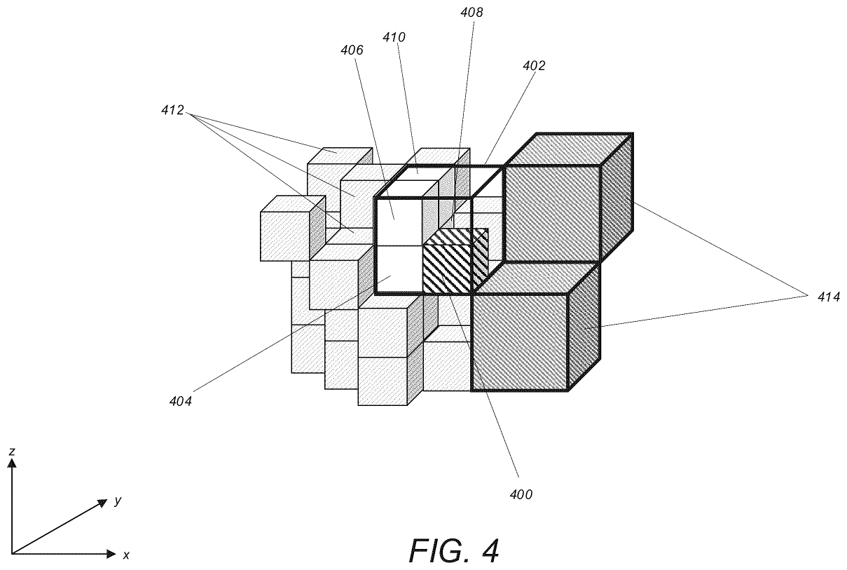

FIG. 4 shows an example neighborhood of cuboids for entropy coding the occupancy of a child cuboid. More specifically, FIG. 4 shows an example neighborhood of cuboids with already-coded occupancy bits. The neighborhood of cuboids with already-coded occupancy bits may be used to entropy code the occupancy bit of a current child cuboid 400. The neighborhood of cuboids with already-coded occupancy bits may be determined, for example, based on the scanning order of an occupancy tree representing the geometry of the cuboids in FIG. 4 as discussed herein. The neighborhood of cuboids, of a current child cuboid, may include one or more of: a cuboid adjacent to the current child cuboid, a cuboid sharing a vertex with the current child cuboid, a cuboid sharing an edge with the current child cuboid, a cuboid sharing a face with the current child cuboid, a parent cuboid adjacent to the current child cuboid, a parent cuboid sharing a vertex with the current child cuboid, a parent cuboid sharing an edge with the current child cuboid, a parent cuboid sharing a face with the current child cuboid, a parent cuboid adjacent to the current parent cuboid, a parent cuboid sharing a vertex with the current parent cuboid, a parent cuboid sharing an edge with the current parent cuboid, a parent cuboid sharing a face with the current parent cuboid, etc. As shown in FIG. 4, current child cuboid 400 may belong to a current parent cuboid 402. Following the scanning order of the occupancy words and occupancy bits of nodes of the occupancy tree, the occupancy bits of four child cuboids 404, 406, 408, and 410, belonging to the same current parent cuboid 402, may have already been coded. The occupancy bit of child cuboids 412 of preceding parent cuboids may have already been coded. The occupancy bits of parent cuboids 414, for which the occupancy bits of child cuboids have not already been coded, may have already been coded. The already-coded occupancy bits of cuboids 404, 406, 408, 410, 412, and 414 may be used to code the occupancy bit of the current child cuboid 400.

The number (e.g., quantity) of possible occupancy configurations (e.g., sets of one or more occupancy words and/or occupancy bits) for a neighborhood of a current child cuboid may be 2^{N}, where N is the number (e.g., quantity) of cuboids in the neighborhood of the current child cuboid with already-coded occupancy bits. The neighborhood of the current child cuboid may comprise several dozens of cuboids. The neighborhood of the current child cuboid (e.g., several dozens of cuboids) may comprise 26 adjacent parent cuboids sharing a face, an, edge, and/or a vertex with the parent cuboid of the current child cuboid and also several adjacent child cuboids sharing a face, an edge, or a vertex with the current child cuboid. The occupancy configuration for a neighborhood of the current child cuboid may have billions of possible occupancy configurations, even limited to a subset of the adjacent cuboids, making its direct use impractical. An encoder and/or decoder may use the occupancy configuration for a neighborhood of the current child cuboid to select the context (e.g., a probability model), among a set of contexts, of a binary entropy coder (e.g., binary arithmetic coder) that may code the occupancy bit of the current child cuboid. The context-based binary entropy coding may be similar to the Context Adaptive Binary Arithmetic Coder (CABAC) used in MPEG-H Part 2 (also known as High Efficiency Video Coding (HEVC)).

An encoder and/or a decoder may use several methods to reduce the occupancy configurations for a neighborhood of a current child cuboid being coded to a practical number (e.g., quantity) of reduced occupancy configurations. The 26 or 64 occupancy configurations of the six adjacent parent cuboids sharing a face with the parent cuboid of the current child cuboid may be reduced to nine occupancy configurations. The occupancy configurations may be reduced by using geometry invariance. An occupancy score for the current child cuboid may be obtained from the 226 occupancy configurations of the 26 adjacent parent cuboids. The score may be further reduced into a ternary occupancy prediction (e.g., “predicted occupied,” “unsure”, or “predicted unoccupied”) by using score thresholds. The number (e.g., quantity) of occupied adjacent child cuboids and the number (e.g., quantity) of unoccupied adjacent child cuboids may be used instead of the individual occupancies of these child cuboids.

An encoder and/or a decoder using/employing one or more of the methods described herein may reduce the number (e.g., quantity) of possible occupancy configurations for a neighborhood of a current child cuboid to a more manageable number (e.g., a few thousands). It has been observed that instead of associating a reduced number (e.g., quantity) of contexts (e.g., probability models) directly to the reduced occupancy configurations, another mechanism may be used, namely Optimal Binary Coders with Update on the Fly (OBUF). An encoder and/or a decoder may implement OBUF to limit the number (e.g., quantity) of contexts to a lower number (e.g., 32 contexts).

OBUF may use a limited number (e.g., 32) of contexts (e.g., probability models). The number (e.g., quantity) of contexts in OBUF may be a fixed number (e.g., fixed quantity). The contexts used by OBUF may be ordered, referred to by a context index (e.g., a context index in the range of 0 to 31), and associated from a lowest virtual probability to a highest virtual probability to code a “1”. A Look-Up Table (LUT) of context indices may be initialized at the beginning of a point cloud coding process. For example, the LUT may initially point to a context with the median virtual probability to code a “1” for all input. The LUT may initially point to a context with the median virtual probability to code a “1”, among the limited number (e.g., quantity) of contexts, for all input. This LUT may take an occupancy configuration for a neighborhood of current child cuboid as input and output the context index associated with the occupancy configuration. The LUT may have as many entries as reduced occupancy configurations (e.g., around a few thousand entries). The coding of the occupancy bit of a current child cuboid may comprise steps including determining the reduced occupancy configuration of the current child node, obtaining a context index by using the reduced occupancy configuration as an entry to the LUT, coding the occupancy bit of the current child cuboid by using the context pointed to (or indicated) by the context index, and updating the LUT entry corresponding to the reduced occupancy configuration, for example, based on the value of the coded occupancy bit of the current child cuboid. The LUT entry may be decreased to a lower context index value, for example, if a binary “0” (e.g., indicating the current child cuboid is unoccupied) is coded. The LUT entry may be increased to a higher context index value, for example, if a binary “1” (e.g., indicating the current child cuboid is occupied) is coded. The update process of the context index may be, for example, based on a theoretical model of optimal distribution for virtual probabilities associated with the limited number (e.g., quantity) of contexts. This virtual probability may be fixed by a model and may be different from the internal probability of the context that may evolve, for example, if the coding of bits of data occurs. The evolution of the internal context may follow a well-known process similar to the process in CABAC.

An encoder and/or a decoder may implement a “dynamic OBUF” scheme. The “dynamic OBUF” scheme may enable an encoder and/or a decoder to handle a much larger number (e.g., quantity) of occupancy configurations for a neighborhood of a current child cuboid, for example, than general OBUF. The use of a larger number (e.g., quantity) of occupancy configurations for a neighborhood of a current child cuboid may lead to improved compression capabilities, and may maintain complexity within reasonable bounds. By using an occupancy tree compressed by OBUF, an encoder and/or a decoder may reach a lossless compression performance as good as 1 bit per point (bpp) for coding the geometry of dense point clouds. An encoder and/or a decoder may implement dynamic OBUF to potentially further reduce the bit rate by more than 25% to 0.7 bpp.

OBUF may not take as input a large variety of reduced occupancy configurations for a neighborhood of a current child cuboid, and may potentially cause a loss of useful correlation. With OBUF, the size of the LUT of context indices may be increased to handle more various occupancy configurations for a neighborhood of a current child cuboid as input. Due to such increase, statistics may be diluted, and compression performance may be worsened. For example, if the LUT has millions of entries and the point cloud has a hundred thousand points, then most of the entries may be never visited (e.g., looked up, accessed, etc.). Many entries may be visited only a few times and their associated context index may not be updated enough times to reflect any meaningful correlation between the occupancy configuration value and the probability of occupancy of the current child cuboid. Dynamic OBUF may be implemented to mitigate the dilution of statistics due to the increase of the number (e.g., quantity) of occupancy configurations for a neighborhood of a current child cuboid. This mitigation may be performed by a “dynamic reduction” of occupancy configurations in dynamic OBUF.

Dynamic OBUF may add an extra step of reduction of occupancy configurations for a neighborhood of a current child cuboid, for example, before using the LUT of context indices. This step may be called a dynamic reduction because it evolves, for example, based on the progress of the coding of the point cloud or, more precisely, based on already visited (e.g., looked up in the LUT) occupancy configurations.

As discussed herein, many possible occupancy configurations for a neighborhood of a current child cuboid may be potentially involved but only a subset may be visited if the coding of a point cloud occurs. This subset may characterize the type of the point cloud. For example, most of the visited occupancy configurations may exhibit occupied adjacent cuboids of a current child cuboid, for example, if AR or VR dense point clouds are being coded. On the other hand, most of the visited occupancy configurations may exhibit only a few occupied adjacent cuboids of a current child cuboid, for example, if sensor-acquired sparse point clouds are being coded. The role of the dynamic reduction may be to obtain a more precise correlation, for example, based on the most visited occupancy configuration while putting aside (e.g., reducing aggressively) other occupancy configurations that are much less visited. The dynamic reduction may be updated on-the-fly. The dynamic reduction may be updated on-the-fly, for example, after each visit (e.g., a lookup in the LUT) of an occupancy configuration, for example, if the coding of occupancy data occurs.

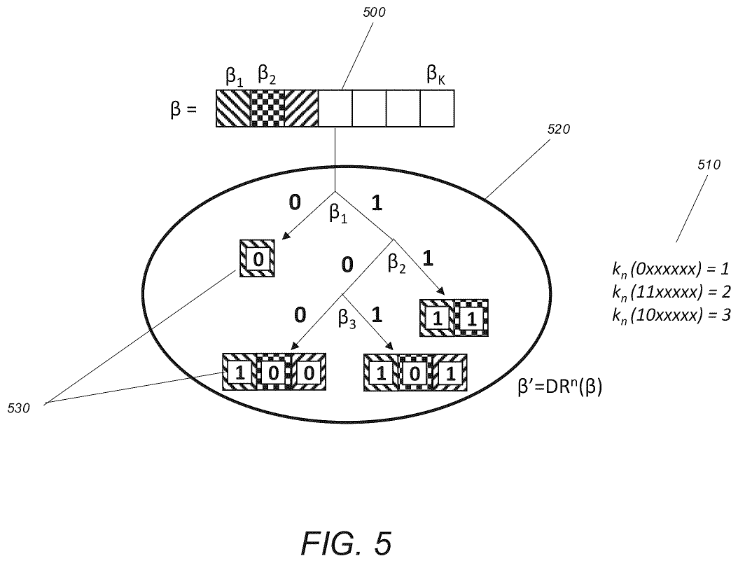

FIG. 5 shows an example of a dynamic reduction function DR that may be used in dynamic OBUF. The dynamic reduction function DR may be obtained by masking bits βⱼ of occupancy configurations 500

$$β = {β}_{1} … {β}_{K}$$

made of K bits. The size of the mask may decrease, for example, if occupancy configurations are visited (e.g., looked up in the LUT) a certain number (e.g., quantity) of times. The initial dynamic reduction function DR⁰ may mask all bits for all occupancy configurations such that it is a constant function DR⁰(β)=0 for all occupancy configurations β. The dynamic reduction function may evolve from a function DRⁿ to an updated function DRⁿ⁺¹. The dynamic reduction function may evolve from a function DRⁿ to an updated function DRⁿ⁺¹, for example, after each coding of an occupancy bit. The function may be defined by

$${β}^{′} = {DR}^{n} ( β ) = {β}_{1} … {β}_{k n ( β )}$$

where kₙ(β) 510 is the number (e.g., quantity) of non-masked bits. The initialization of DR⁰ may correspond to k₀(β)=0, and the natural evolution of the reduction function toward finer statistics may lead to an increasing number (e.g., quantity) of non-masked bits kₙ(β)≤kₙ₊₁(β). The dynamic reduction function may be entirely determined by the values of kₙ for all occupancy configurations β.

The visits (e.g., instances of a lookup in the LUT) to occupancy configurations may be tracked by a variable NV(β′) for all dynamically reduced occupancy configurations β′=DRⁿ(β). The corresponding number (e.g., quantity) of visits NV(β^{V}′) may be increased by one, for example, after each instance of coding of an occupancy bit based on an occupancy configuration β^{V}. If this number (e.g., quantity) of visits NV(β^{V}′) is greater than a threshold thy,

$$N V ( {β}^{V ′} ) > t {h}_{V}$$

then the number (e.g., quantity) of unmasked bits kₙ(β) may be increased by one for all occupancy configurations β being dynamically reduced to β^{V}′. This corresponds to replacing the dynamically reduced occupancy configuration β^{V}′ by the two new dynamically reduced occupancy configurations β⁰′ and β¹′ defined by

$${β}^{0 ′} = {β}^{V ′} 0 = {β}_{1}^{V} … {β}_{kn ( β )}^{V} 0 and {β}^{1 ′} = {β}^{V ′} 1 = {β}_{1}^{V} … {β}_{kn ( β )}^{V} 1.$$

In other words, the number (e.g., quantity) of unmasked bits has been increased by one kₙ₊₁(β)=kₙ(β)+1 for all occupancy configurations β such that DRⁿ(β)=β^{V}′. The number (e.g., quantity) of visits of the two new dynamically reduced occupancy configurations may be initialized to zero

$$N V ( {β}^{0 ′} ) = N V ( {β}^{1 ′} ) = 0. \qquad ( I )$$

At the start of the coding, the initial number (e.g., quantity) of visits for the initial dynamic reduction function DR⁰ may be set to

$$N V ( D {R}^{0} ( β ) ) = N V ( 0 ) = 0 ,$$

and the evolution of NV on dynamically reduced occupancy configurations may be entirely defined.

The corresponding LUT entry LUT[β^{V}′] may be replaced by the two new entries LUT[β⁰′] and LUT[β¹′] that are initialized by the coder index associated with β^{V}′. The corresponding LUT entry LUT[β^{V}′] may be replaced by the two new entries LUT[β⁰′] and LUT[β¹′] that are initialized by the coder index associated with β^{V}′, for example, if a dynamically reduced occupancy configuration β^{V}′ is replaced by the two new dynamically reduced occupancy configurations β⁰′ and β¹′,

$$L U T [ {β}^{0 ′} ] = L U T [ {β}^{1 ′} ] = L U T [ {β}^{V ′} ] , \qquad ( II )$$

and then evolve separately. The evolution of the LUT of coder indices on dynamically reduced occupancy configurations may be entirely defined.

The reduction function DRⁿ may be modeled by a series of growing binary trees Tⁿ 520 whose leaf nodes 530 are the reduced occupancy configurations β′=DRⁿ(β). The initial tree may be the single root node associated with 0=DR⁰(β). The replacement of the dynamically reduced to β^{V}′ by β⁰′ and β¹′ may correspond to growing the tree Tⁿ from the leaf node associated with β^{V}′, for example, by attaching to it two new nodes associated with β⁰′ and β¹′. The tree Tⁿ⁺¹ may be obtained by this growth. The number (e.g., quantity) of visits NV and the LUT of context indices may be defined on the leaf nodes and evolve with the growth of the tree through equations (I) and (II).

The practical implementation of dynamic OBUF may be made by the storage of the array NV[β′] and the LUT[β′] of context indices, as well as the trees Tⁿ 520. An alternative to the storage of the trees may be to store the array kₙ[β] 510 of the number (e.g., quantity) of non-masked bits.

A limitation for implementing dynamic OBUF may be its memory footprint. In some applications, a few million occupancy configurations may be practically handled, leading to about 20 bits βᵢ constituting an entry configuration β to the reduction function DR. Each bit βᵢ may correspond to the occupancy status of a neighboring cuboid of a current child cuboid or a set of neighboring cuboids of a current child cuboid.

Higher (e.g., more significant) bits βᵢ (e.g., β₀, β₁, etc.) may be the first bits to be unmasked. Higher (e.g., more significant) bits βᵢ (e.g., β₀, β₁, etc.) may be the first bits to be unmasked, for example, during the evolution of the dynamic reduction function DR. The order of neighbor-based information put in the bits βᵢ may impact the compression performance. Neighboring information may be ordered from higher (e.g., highest) priority to lower priority and put in this order into the bits βᵢ, from higher to lower weight. The priority may be, from the most important to the least important, occupancy of sets of adjacent neighboring child cuboids, then occupancy of adjacent neighboring child cuboids, then occupancy of adjacent neighboring parent cuboids, then occupancy of non-adjacent neighboring child nodes, and finally occupancy of non-adjacent neighboring parent nodes. Adjacent nodes sharing a face with the current child node may also have higher priority than adjacent nodes sharing an edge (but not sharing a face) with the current child node. Adjacent nodes sharing an edge with the current child node may have higher priority than adjacent nodes sharing only a vertex with the current child node.

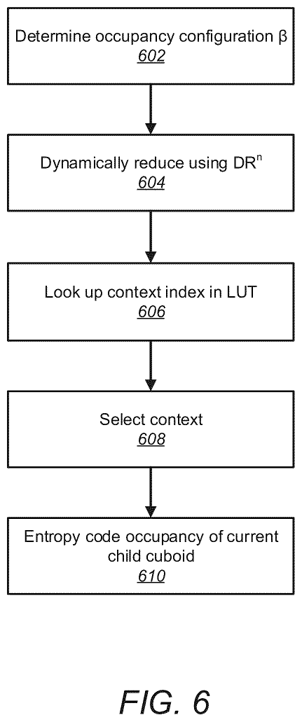

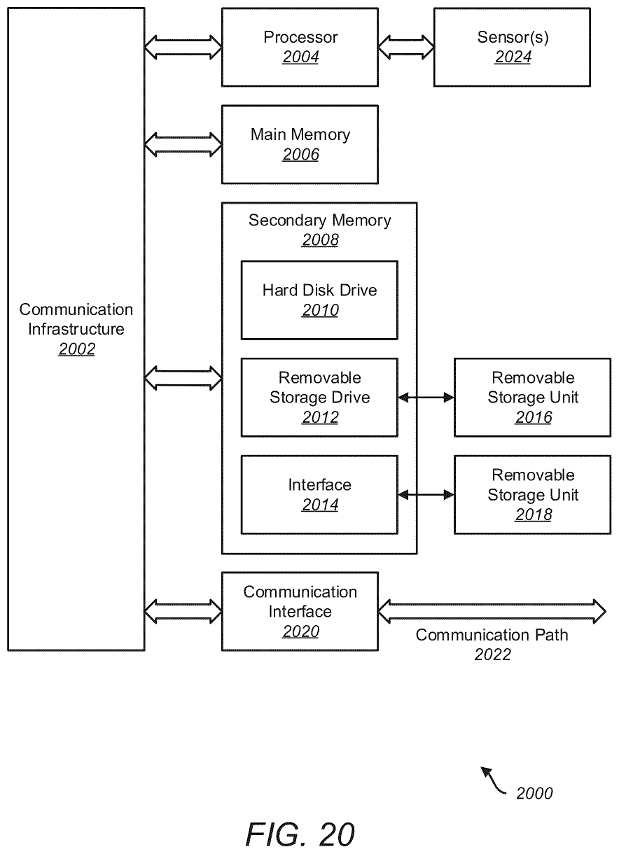

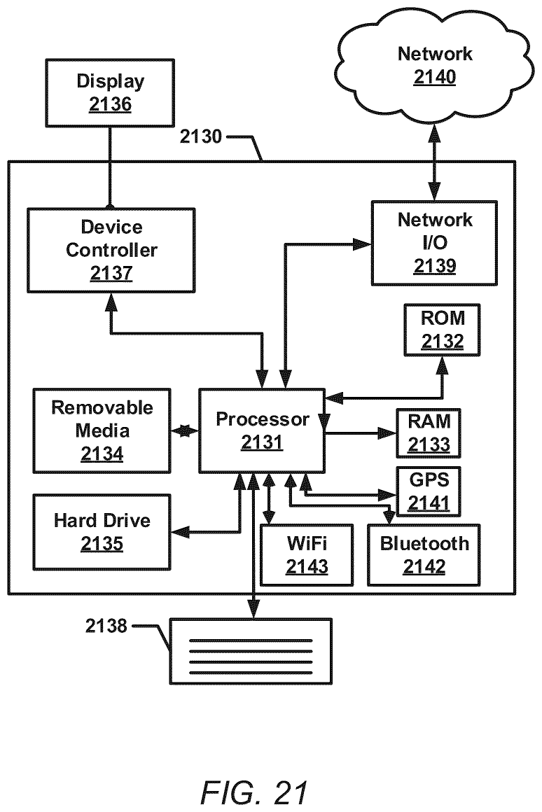

FIG. 6 shows an example method for coding occupancy of a cuboid using dynamic OBUF. More specifically, FIG. 6 shows an example method for coding occupancy bit of a current child cuboid using dynamic OBUF. One or more steps of FIG. 6 may be performed by an encoder and/or a decoder (e.g., the encoder 114 and/or decoder 120 in FIG. 1). All or portions of the flowchart may be implemented by a coder (e.g., the encoder 114 and/or decoder 120 in FIG. 1), an example computer system 2000 in FIG. 20, and/or an example computing device 2130 in FIG. 21.

At step 602, an occupancy configuration (e.g., occupancy configuration β) of the current child cuboid may be determined. The occupancy configuration (e.g., occupancy configuration β) of the current child cuboid may be determined, for example, based on occupancy bits of already-coded cuboids in a neighborhood of the current child cuboid. At step 604, the occupancy configuration (e.g., occupancy configuration β) may be dynamically reduced. The occupancy configuration may be dynamically reduced, for example, using a dynamic reduction function DRⁿ. For example, the occupancy configuration β may be dynamically reduced into a reduced occupancy configuration β′=DRⁿ(β). At step 606, context index may be looked up, for example, in a look-up table (LUT). For example, the encoder and/or decoder may look up context index LUT[β′] in the LUT of the dynamic OBUF. At step 608, context (e.g., probability model) may be selected. For example, the context (e.g., probability model) pointed to by the context index may be selected. At step 610, occupancy of the current child cuboid may be entropy coded. For example, the occupancy bit of the current child cuboid may be entropy coded (e.g., arithmetic coded), for example, based on the context.

Although not shown in FIG. 6, the encoder and/or decoder may update the reduction function and/or update the context index. For example, the encoder and/or decoder may update the reduction function DRⁿ into DRⁿ⁺¹ and/or update the context index LUT[β′], for example, based on the occupancy bit of the current child cuboid. The method of FIG. 6 may be repeated for additional or all child cuboids of parent cuboids corresponding to nodes of the occupancy tree in a scan order, such as the scan order discussed herein with respect to FIG. 3.

In general, the occupancy tree is a lossless compression technique. The occupancy tree may be adapted to provide lossy compression, for example, by modifying the point cloud on the encoder side (e.g., down-sampling, removing points, moving points, etc.). The performance of the lossy compression may be weak. The lossy compression may be a useful lossless compression technique for dense point clouds.

One approach to lossy compression for point cloud geometry may be to set the maximum depth of the occupancy tree to not reach the smallest volume size of one voxel but instead to stop at a bigger volume size (e.g., N×N×N cuboids (e.g., cubes), where N>1). The geometry of the points belonging to each occupied leaf node associated with the bigger volumes may then be modeled. This approach may be particularly suited for dense and smooth point clouds that may be locally modeled by smooth functions such as planes or polynomials. The coding cost may become the cost of the occupancy tree plus the cost of the local model in each of the occupied leaf nodes.

A scheme for modeling the geometry of the points belonging to each occupied leaf node associated with a volume size larger than one voxel may use sets of triangles as local models. The scheme may be referred to as the “TriSoup” scheme. TriSoup is short for “Triangle Soup” because the connectivity between triangles may not be part of the models. An occupied leaf node of an occupancy tree that corresponds to a cuboid with a volume greater than one voxel may be referred to as a TriSoup node. An edge belonging to at least one cuboid corresponding to a TriSoup node may be referred to as a TriSoup edge. A TriSoup node may comprise a presence flag (sₖ) for each TriSoup edge of its corresponding occupied cuboid. A presence flag (sₖ) of a TriSoup edge may indicate whether a TriSoup vertex (Vₖ) is present or not on the TriSoup edge. At most one TriSoup vertex (Vₖ) may be present on a TriSoup edge. For each vertex (Vₖ) present on a TriSoup edge of an occupied cuboid, the TriSoup node corresponding to the occupied cuboid may comprise a position (pₖ) of the vertex (Vₖ) along the TriSoup edge.

In addition to the occupancy words of an occupancy tree, an encoder may entropy encode the TriSoup vertex presence flags and positions of each TriSoup edge belonging to TriSoup nodes of the occupancy tree. A decoder may similarly entropy decode the TriSoup vertex presence flags and positions of each TriSoup edge belonging to a TriSoup node of the occupancy tree, in addition to the occupancy words of the occupancy tree.

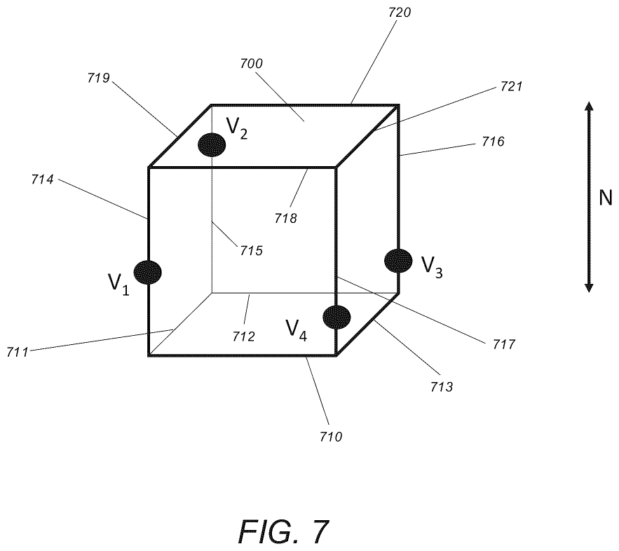

FIG. 7 shows an example of an occupied cuboid (e.g., cube) 700. More specifically, FIG. 7 shows an example of an occupied cuboid (e.g., cube) 700 of size N×N×N (where N>1) that corresponds to a TriSoup node of an occupancy tree. An occupied cuboid 700 may comprise edges (e.g., TriSoup edges 710-721). The TriSoup node, corresponding to the occupied cuboid 700, may comprise a presence flag (sₖ) for each edge (e.g., each TriSoup edge of the TriSoup edges 710-721). For example, the presence flag of a TriSoup edge 714 may indicate that a TriSoup vertex V₁ is present on the TriSoup edge 714. The presence flag of a TriSoup edge 715 may indicate that a TriSoup vertex V₂ is present on the TriSoup edge 715. The presence flag of a TriSoup edge 716 may indicate that a TriSoup vertex V₃ is present on the TriSoup edge 716. The presence flag of a TriSoup edge 717 may indicate that a TriSoup vertex V₄ is present on the TriSoup edge 717. The presence flags of the remaining TriSoup edges each may indicate that a TriSoup vertex is not present on their corresponding TriSoup edge. The TriSoup node, corresponding to the occupied cuboid 700, may comprise a position for each TriSoup vertex present along one of its TriSoup edges 710-721. More specifically, the TriSoup node, corresponding to the occupied cuboid 700, may comprise a position p₁ for TriSoup vertex V₁, a position p₂ for TriSoup vertex V₂, a position p₃ for TriSoup vertex V₃, and a position p₄ for TriSoup vertex V₄.

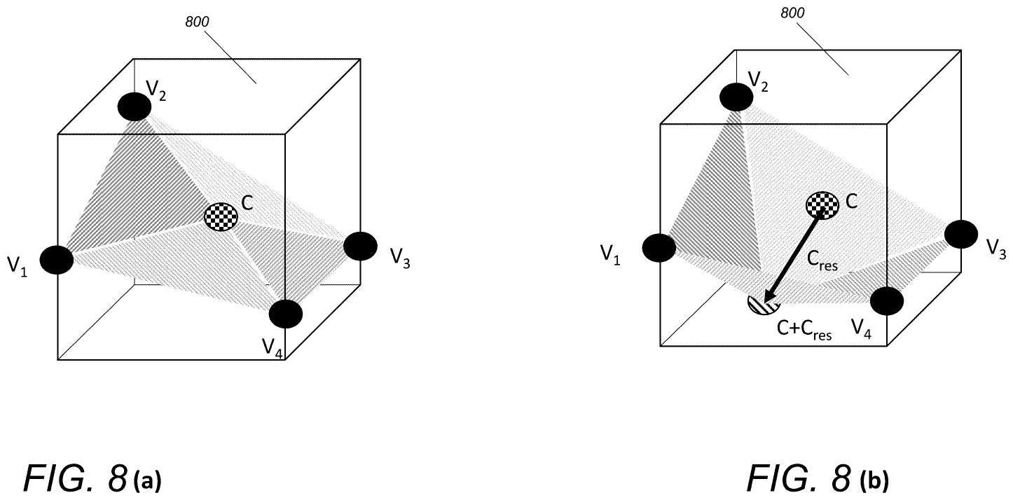

FIG. 8(a) shows an example cuboid (e.g., cube) 800 corresponding to a TriSoup node. A cuboid 800 may correspond to a TriSoup node with a number K of TriSoup vertices Vₖ. Within cuboid 800, TriSoup triangles may be constructed from the TriSoup vertices Vₖ. TriSoup triangles may be constructed from the TriSoup vertices Vₖ, for example, if at least three (K≥3) TriSoup vertices are present on the TriSoup edges of cuboid 800. For example, with respect to FIG. 8(a), four TriSoup vertices may be present and TriSoup triangles may be constructed. The TriSoup triangles may be constructed around the centroid vertex C defined as the mean of the TriSoup vertices Vₖ. A dominant direction may be determined, then vertices Vₖ may be ordered by turning around this direction, and the following K TriSoup triangles may be constructed: V₁V₂C, V₂V₃C, . . . , V_{K}V₁C. The dominant direction may be chosen among the three directions respectively parallel to the axes of the 3D space to increase or maximize the 2D surface of the triangles, for example, if the triangles are projected along the dominant direction. By doing so, the dominant direction may be somewhat perpendicular to a local surface defined by the points of the point cloud belonging to the TriSoup node.

FIG. 8(b) shows an example refinement to the TriSoup model. The TriSoup model may be refined by coding a centroid residual value. A centroid residual value Cᵣₑₛ may be coded into the bitstream. A centroid residual value Cᵣₑₛ may be coded into the bitstream, for example, to use C+Cᵣₑₛ instead of C as a pivoting vertex for the triangles. By using C+Cₑs as the pivoting vertex for the triangles, the vertex C+Cᵣₑₛ may be closer to the points of the point cloud than the centroid C, the reconstruction error may be lowered, leading to lower distortion at the cost of a small increase in bitrate needed for coding Cᵣₑₛ.

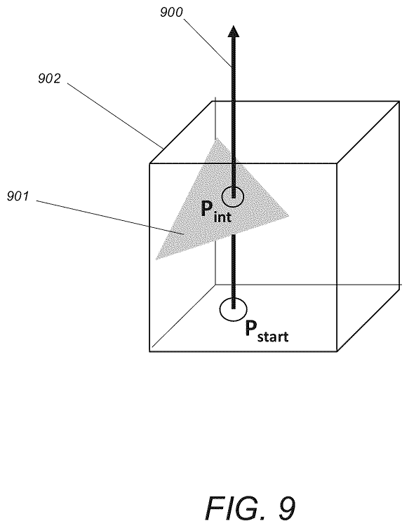

FIG. 9 shows an example of voxelization. Voxelization may refer to reconstruction of a decoded point cloud from a set of TriSoup triangles. Voxelization may be performed by ray tracing for each triangle individually. Voxelization may be performed by ray tracing for each triangle individually, for example, before removing duplicated points between voxelized triangles. As shown in FIG. 9, rays 900 may be launched parallel to one of the three axes of the 3D space. Rays 900 may be launched starting from integer coordinates Pₛₜₐᵣₜ. The intersection Pᵢₙₜ (if any) of the rays 900 with a TriSoup triangle 901 belonging to a cuboid (e.g., cube) 902 corresponding to a TriSoup node may be rounded to obtain a decoded point. This intersection Pᵢₙₜ may be found, for example, using the Möller-Trumbore algorithm.

A presence flag (sₖ) and, if the presence flag (sₖ) may indicate the presence of a vertex, a position (pₖ) of a current TriSoup edge may be entropy coded. The presence flag (sₖ) and position (pₖ) may be individually or collectively referred to as vertex information or TriSoup vertex information. A presence flag (sₖ) and, if the presence flag (sₖ) indicates the presence of a vertex, a position (pₖ) of a current TriSoup edge may be entropy coded, for example, based on already-coded presence flags and positions of TriSoup edges that neighbor the current TriSoup edge. A presence flag (sₖ) and, if the presence flag (sₖ) may indicate the presence of a vertex, a position (pₖ) of a current TriSoup edge may be additionally or alternatively entropy coded. The presence flag (sₖ) and the position (pₖ) of a current TriSoup edge may be additionally or alternatively entropy coded, for example, based on occupancies of cuboids that neighbor the current TriSoup edge. Similar to the entropy coding of the occupancy bits of the occupancy tree, a configuration β_{TS} for a neighborhood (also referred to as a neighborhood configuration β_{TS}) of a current TriSoup edge may be obtained and dynamically reduced into a reduced configuration β_{TS}′=DRⁿ(β_{TS}), for example, by using a dynamic OBUF scheme for TriSoup. A context index LUT[β_{TS}′] may be obtained from the OBUF LUT. At least a part of the vertex information of the current TriSoup edge may be entropy coded using the context (e.g., probability model) pointed to by the context index.

The TriSoup vertex position (pₖ) (if present) along its TriSoup edge may be binarized. The TriSoup vertex position (pₖ) (if present) along its TriSoup edge may be binarized, for example, to use a binary entropy coder to entropy code at least part of the vertex information of the current TriSoup edge. A number (e.g., quantity) of bits N_{b} may be set for the quantization of the TriSoup vertex position (pₖ) along the TriSoup edge of length N. The TriSoup edge of length N may be uniformly divided into 2^{Nb} quantization intervals. By doing so, the TriSoup vertex position (pₖ) may be represented by N_{b} bits (pₖ^{j}, j=1, . . . , N_{b}) that may be individually coded by the dynamic OBUF scheme as well as the bit corresponding to the presence flag (sₖ). The neighborhood configuration β_{TS}, the OBUF reduction function DRⁿ, and the context index may depend on the nature of the coded bit (e.g., presence flag (sₖ), highest position bit (pₖ¹), second highest position bit (pₖ²), etc.). There may practically be several dynamic OBUF schemes, each dedicated to a specific bit of information (e.g., presence flag (sₖ) or position bit (pₖ^{j})) of the vertex information.

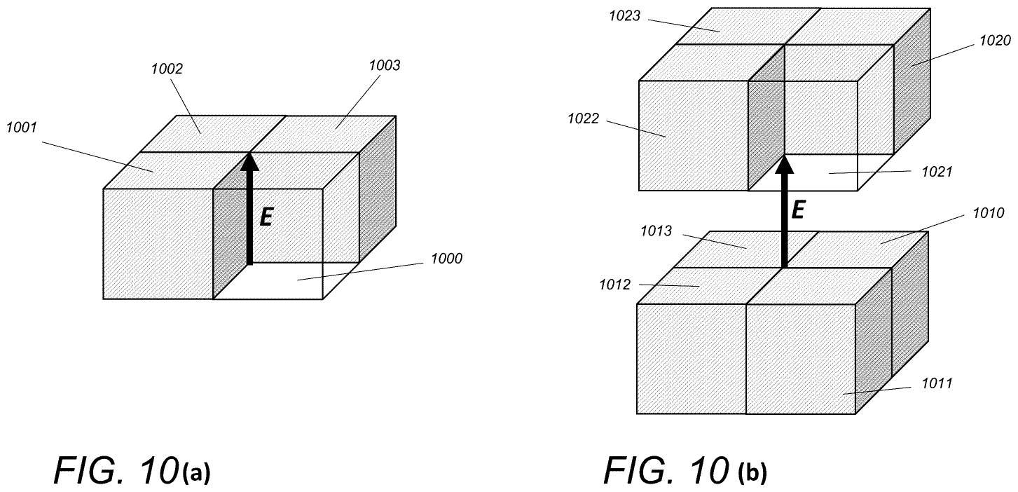

FIG. 10(a) and FIG. 10(b) show example cuboids. More specifically, FIG. 10(a) and FIG. 10(b) show 12 cuboids 1000-1003, 1010-1013, and 1020-1023 with volumes that intersect a current TriSoup edge E being entropy coded. The current TriSoup edge E may be an edge of cuboids 1000-1003. A start point of the current TriSoup edge E may intersect cuboids 1010-1013. An end point of the current TriSoup edge E may intersect cuboids 1020-1023. The occupancy bits of one or more of the 12 cuboids 1000-1003, 1010-1013, and 1020-1023 may be used to determine a neighborhood configuration β_{TS} for the current TriSoup edge E.

TriSoup edges may be oriented from a start point to an end point following the orientation of one of the three axes of the 3D space that the edges are parallel to. A global ordering of the TriSoup edges may be defined as the lexicographic order over the couple (e.g., start point, end point). Vertex information related to the TriSoup edges may be coded following the TriSoup edge ordering. A causal neighborhood of a current TriSoup edge may be obtained from the neighboring already-coded TriSoup edges of the current TriSoup edge.

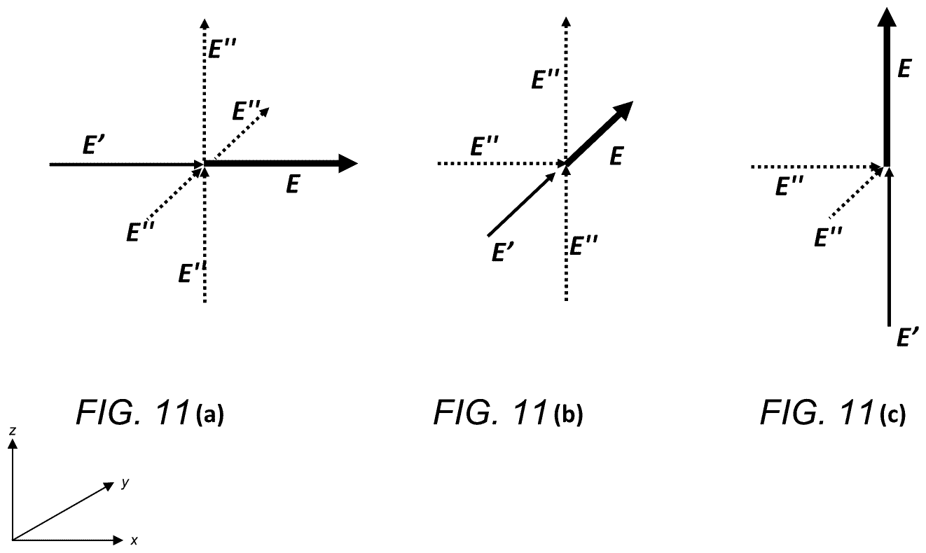

FIG. 11(a), FIG. 11(b), and FIG. 11(c) show TriSoup edges that may be used to entropy code a current TriSoup edge. FIG. 11(a), FIG. 11(b), and FIG. 11(c) show TriSoup edges (E′ and E″) that may be used to entropy code a current edge E. In some instances, five TriSoup edges (E′ and E″) may be used to entropy code a current edge E. The five TriSoup edges may include,
the edge E′ parallel to the current TriSoup edge E and having an end point equal to the start point of the current TriSoup edge E, and
the four edges E″ perpendicular to the current TriSoup edge E and having a start or end point equal to the start point of the current TriSoup edge E.

Depending on the direction of the current TriSoup edge E, either two (FIG. 11(c) for direction z), three (FIG. 11(b) for direction y), or four (FIG. 11(a) for direction x) of the four perpendicular TriSoup edges may have been already coded and their vertex information may be used to construct the neighborhood configuration β_{TS} for the current TriSoup edge E. The TriSoup edge E′ may have already been coded for each direction of the current TriSoup edge E and its vertex information may be used to construct the neighborhood configuration β_{TS} for the current TriSoup edge E independent of its direction.

A neighborhood configuration β_{TS} for a current TriSoup edge E may be obtained from one or more of occupancy bits of cuboids and/or from the vertex information of neighboring already-coded TriSoup edges. For example, a neighborhood configuration β_{TS} for a current TriSoup edge E may be obtained from one or more of the 12 occupancy bits of the 12 cuboids shown in FIG. 10(a) and FIG. 10(b) and from the vertex information of the at most five neighboring already-coded TriSoup edges (E′ and E″) shown in FIG. 11(a), FIG. 11(b), and FIG. 11(c).

Performance may be improved by using inter frame prediction, for example, in video compression. Bitrates needed to compress inter frames may be typically one to two orders of magnitude lower than bitrates of intra frames that, by definition, do not use inter frame prediction. Point cloud data may behave differently because the 3D geometry is coded, unlike video coding where typically only the attributes (e.g., colors) are coded after projection of the 3D geometry onto a 2D plane (e.g., a camera sensor). Even if 2D-projected attributes are expected to temporally have a higher correlation than their underlying 3D geometry, it may be expected that inter frame prediction between 3D point clouds may provide improved compression capability than intra frame prediction alone within a point cloud. The octree may benefit from inter frame prediction and geometry compression gains.

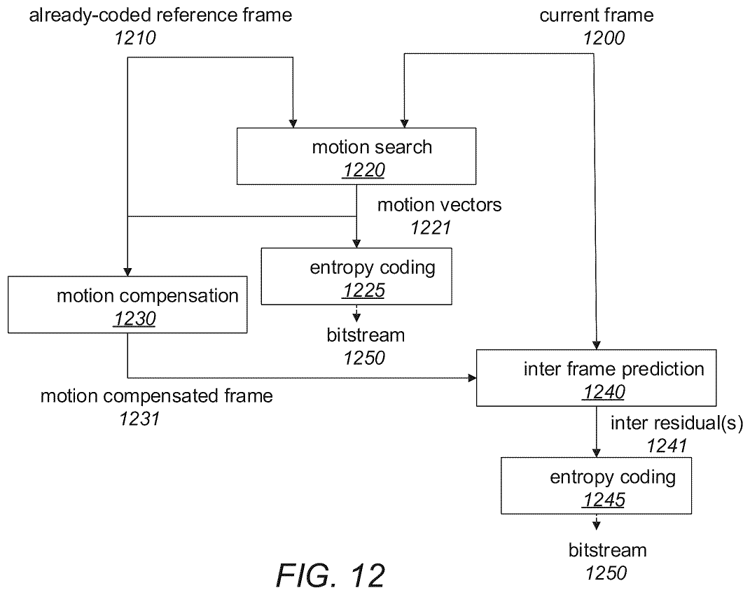

FIG. 12 shows an example coding method. One or more steps of FIG. 12 may be performed by an encoder (e.g., the encoder 114 in FIG. 1). All or portions of the flowchart may be implemented by a coder (e.g., the encoder 114 and/or decoder 120 in FIG. 1), an example computer system 2000 in FIG. 20, and/or an example computing device 2130 in FIG. 21.

A general framework of inter frame prediction for 3D point clouds may be similar to the one of video compression, as shown in FIG. 12 for the coding (e.g., encoding) method. A current frame (e.g., image or point cloud) 1200 may be coded based on an already-coded reference frame (e.g., image or point cloud) 1210. A motion search 1220 may be performed from the already-coded reference frame 1210 toward the current frame 1200, for example, to obtain motion vectors 1221 that may represent a motion flow between the two frames 1210 and 1200. Motion vectors may be 2-component (or 2D) vectors representing the motion from reference blocks of pixels to current blocks of pixels, for example, in video compression. Motion vectors may be 3-component (or 3D) vectors representing the motion from reference sets of 3D points to current sets of 3D points, for example, in point cloud compression. Motion vectors 1221 may be coded (e.g., entropy coded) (at step 1225, as shown in FIG. 12) into a bitstream 1250. The reference frame 1210 may be motion compensated (at step 1230, as shown in FIG. 12) to obtain a motion compensated frame 1231. Motion compensation may involve moving the pixels of the reference image according to the 2D motion vectors, and/or moving the points of the reference point cloud according to the 3D motion vectors. The obtained motion compensated frame 1231 may be closer to the current frame 1200 than the reference frame 1210. The obtained motion compensated frame 1231 may be closer to the current frame 1200 than the reference frame 1210, for example, in that the color difference and/or point distance between the motion compensated frame 1231 and the current frame 1200 may be smaller than that between the reference frame 1210 and the current frame 1200. The obtained motion compensated frame 1231 may be closer to the current frame 1200 than the reference frame 1210, for example, in that the color difference and/or point distance between the motion compensated frame 1231 and the current frame 1200 may be, on average, smaller than that between the reference frame 1210 and the current frame 1200. At step 1240, inter frame prediction may be performed to obtain inter residual(s) 1241. The inter residual(s) 1241 may be coded (e.g., entropy coded) (at step 1245, as shown in FIG. 12) into the bitstream 1250. The inter residual(s) 1241 may carry more compressible information than the current frame 1200 or a current frame that has undergone an intra prediction process. The coding (e.g., entropy coding) 1245 may be more efficient for obtaining a bitstream 1250 with reduced size compared to a bitstream obtained by coding the current frame 1200 that has not benefited from inter frame prediction.

Inter residuals may be constructed as the difference of colors, pixel per pixel, between a current block of pixels belonging to the current frame (e.g., image) and a co-located compensated block of pixels belonging to the motion compensated frame (e.g., image), for example, in video coding. Inter residuals may be arrays of color differences that may have a small magnitude and thus may be efficiently compressed.

There is no such concept as the difference between two sets of points and the concept of an inter residual may not be straightforwardly generalized to point clouds, for example, in point cloud compression. For prediction of an octree representing a point cloud, the concept of inter residual may be replaced by conditional entropy coding where conditional information for performing conditional entropy coding may be constructed, for example, based on a motion compensated point cloud. This may be extended to the framework of dynamic OBUF.

As described herein, a current occupancy bit of an octree may be coded by a coder (e.g., entropy coder) selected by the output of a dynamic OBUF LUT of coder indices that may take a neighborhood configuration β as input. The neighborhood configuration β may be constructed, for example, based on already-coded occupancy bits associated with neighboring volumes relative to the current volume. The current volume may be associated with the current node whose occupancy may be signaled by the current occupancy bit. The construction of the neighborhood configuration β may be extended using inter frame information. An inter predictor occupancy bit may be defined for a current occupancy bit as a bit representative of the presence of at least one point of a motion compensated point cloud within the current volume. A strong correlation between the current occupancy bit and the inter predictor occupancy bit may exist, for example, if motion compensation is efficient, because the current compensated point cloud and motion compensated point cloud should be close to each other. Using the inter predictor occupancy bit as a bit of the neighborhood configuration β may lead to better compression performance of the octree (e.g., dividing the size of the octree bitstream by a factor two).

A motion field between octrees may be made of 3D motion vectors associated with 3D prediction units (PU). The 3D prediction units (PU) may have volumes that may include at least a part of one or several volumes (e.g., cuboids) associated with nodes of the octree. A motion compensation may be performed volume per volume, for example, based on the 3D motion vectors, to obtain a motion compensated point cloud in one or more current volumes. An inter predictor occupancy bit may be obtained, for example, based on the presence of at least one point of the motion compensated point cloud.

For lossy coding of dense point clouds, a TriSoup method may be more efficient than an octree only approach, which is primarily a lossless method. Even using inter frame prediction as described herein, the octree alone approach may not be competitive against TriSoup for lossy coding of point clouds. TriSoup is an enhancement of an uncomplete octree, and inter prediction for octree may benefit the overall TriSoup scheme by reducing the bitrate of the octree over which TriSoup is an enhancement. The TriSoup method may not benefit fully from an inter frame correlation because TriSoup vertex information (e.g., TriSoup vertex presence flag (sₖ), TriSoup vertex position (pₖ), and centroid residual value (Cᵣₑₛ)) may not be coded based on any reference frame.

Examples of the present disclosure may code TriSoup vertex information based on a motion compensated point cloud. The motion compensated point cloud may be determined, for example, if the coding of the underlying octree occurs as discussed herein. An encoder and/or a decoder may determine one or more symbols of a neighborhood configuration β_{TS} of a current TriSoup edge E, for example, based at least on the motion compensated point cloud. The encoder and/or the decoder may select a context (or probability model) for coding the vertex information of the current TriSoup edge E, for example, based on the neighborhood configuration β_{TS}. The encoder and/or the decoder may select the context for coding the vertex information of the current TriSoup edge E, for example, based on a reduced configuration β_{TS}′=DRⁿ(β_{TS}) representing a subset of the symbols of the neighborhood configuration β_{TS}. The encoder and/or the decoder may select the context, for example, based on an OBUF Look-Up Table (LUT) that may map the neighborhood configuration β_{TS} or the reduced configuration β_{TS}′ to an index of the context. The encoder and/or the decoder may code (e.g., entropy code; e.g., arithmetic code) the vertex information of the current TriSoup edge E, for example, based on the context.

The use of a motion compensated point cloud to code TriSoup vertex information may add inter frame correlation to the intra frame correlation (e.g., neighboring edges and nodes) that a Tri Soup neighborhood configuration β_{TS} may be based upon. Adding inter frame correlation to the intra frame correlation may lead to a better selection of the coder (e.g., entropy coder; e.g., its associated probability or probability model) and improve the compression of the TriSoup information, resulting in a reduction of the overall number of bits needed to represent the geometry of the point cloud after compression.

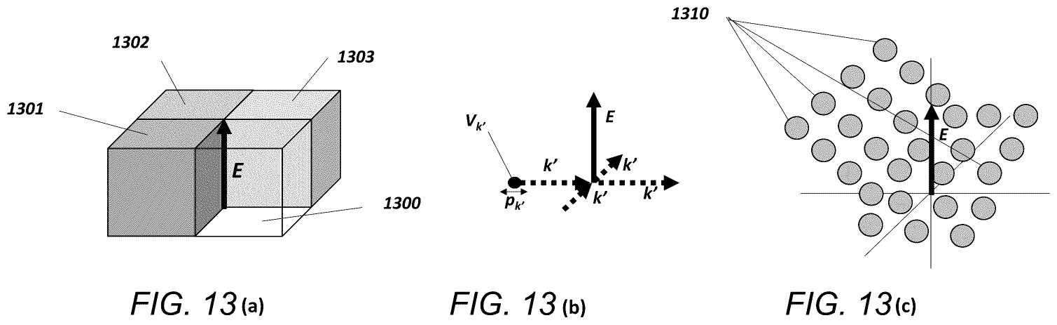

FIGS. 13(a)-13(c) show example types of neighborhood information. More specifically, FIGS. 13(a)-13(c) show three example types of neighborhood information that may be used by an encoder and/or a decoder to compress TriSoup vertex information associated with a current edge E. FIG. 13(a) shows occupancies of neighboring octree leaf nodes (e.g., nodes 1300 to 1303), relative to a current edge E. FIG. 13(b) shows TriSoup vertex information (s_{k′}, p_{k′}) of already-coded neighboring edges k′, relative to a current edge E, that may have a TriSoup vertex V_{k′}. FIG. 13(c) shows a motion compensated point cloud made of points 1310 that may in part belong to some still-to-be-defined neighborhood of the current edge E.

An encoder and/or a decoder may determine one or more symbols of a neighborhood configuration β_{TS} of a current TriSoup edge E. An encoder and/or a decoder may determine one or more symbols of a neighborhood configuration β_{TS} of a current TriSoup edge E, for example, based on one or more of the three types of neighborhood information shown in FIGS. 13(a)-13(c). The encoder and/or the decoder may select a context (or probability model) for coding the vertex information of the current TriSoup edge E, for example, based on the neighborhood configuration β_{TS}. The encoder and/or the decoder may select the context for coding the vertex information of the current TriSoup edge E, for example, based on a reduced configuration β_{TS}′=DRⁿ(β_{TS}). The reduced configuration β_{TS}′ may represent a subset of the symbols of the neighborhood configuration β_{TS}. The encoder and/or the decoder may select the context, for example, based on an OBUF LUT that maps the neighborhood configuration β_{TS} or the reduced configuration β_{TS}′ to an index of the context. The encoder and/or the decoder may code (e.g., entropy code; e.g., arithmetic code) the vertex information of the current TriSoup edge E, for example, based on the context.

The occupancy of one or more of the points of the motion compensated point cloud may be used, at least in part, to construct the neighborhood configuration β_{TS}. For example, individual occupancies of neighboring point locations to the current edge E may be used directly as bits constituting the neighborhood configuration β_{TS}. The number of such occupancy bits may be too large to be contained in the TriSoup neighborhood configuration β_{TS} and, instead, these occupancies may be combined to obtain at least one bit of the neighborhood configuration β_{TS}.

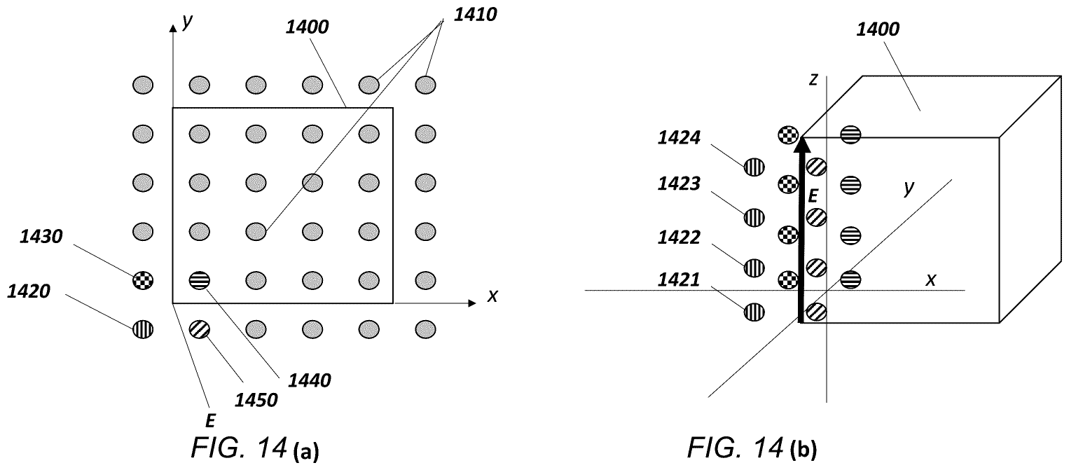

FIGS. 14(a)-14(b) show example point locations of a point cloud that neighbor a current edge E of a TriSoup node. A volume 1400 associated with the TriSoup node may be represented in 3D as shown for example in FIG. 14(b). The TriSoup node may be an occupied leaf node of an underlying octree. The volume 1400 associated with the TriSoup node may be represented in 2D, projected along the z axis, as shown for example in FIG. 14(a). The volume 1400 may be a 3D cuboid that may project as a square on the xy plane. For example, in FIG. 14(b), the volume 1400 may have a size of 4×4×4 point locations. The current edge E being coded may be represented as a vertical edge (along the z axis) of the volume 1400. In FIG. 14(a), potential point locations of the point cloud may be represented by grey points 1410. The volume 1400 may encompass 4×4×4 point locations and the faces of the volume may be located between point locations. In the 2D projection, there may be a plurality of closest point locations relative to the current edge E. For example, in the 2D projection of FIG. 14(a), there may be four closest point locations 1420, 1430, 1440 and 1450 relative to the current edge E. A closest point location in the 2D projection may correspond to a plurality of 3D point locations in a 3D representation (e.g., a 3D cuboid). For example, the 2D point location 1420 may correspond to several 3D point locations of FIG. 14(b), for example, point locations 1421 to 1424. For example, a 3D point neighborhood relative to the current edge E may be made of the 16 points shown in FIG. 14(b).

A set of point locations constituting a point neighborhood of a current edge E of a length L (not shown in FIGS. 14(a)-14(b)) may comprise a quantity of closest point locations. The set of point locations constituting a point neighborhood of a current edge E of a length L (not shown in FIGS. 14(a)-14(b)) may comprise a quantity of closest point locations with a predetermined distance from the current edge E along each coordinate perpendicular to the current edge E. The coordinate along an axis parallel to the current edge E may be contained in an edge interval. The edge interval is the projection of the edge on the axis. For example, if the axis is vertical, points in the neighborhood are not below or above the edge. For example, in FIG. 14, the set of point locations constituting the point neighborhood of the current edge E of length L may comprise the 4*L closest point locations. Of these closest point locations, distance from the current edge E along each coordinate (or in a direction) perpendicular to the current edge E may be at most (or no more than) half the minimum distance between point locations, and whose coordinate along the axis parallel to the current edge E may be contained in the edge interval. For example, a different set of point locations may constitute the point neighborhood of the current edge E of length L. For example, the set of point locations may comprise more locations or less locations, including point locations with greater distances from the current edge E.

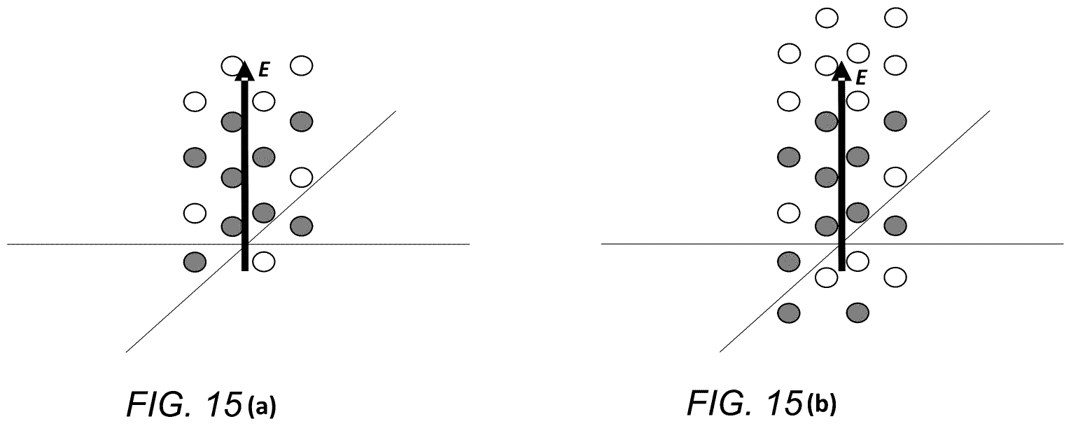

FIG. 15(a) shows an example occupancy of a point neighborhood in a motion compensated point cloud. More specifically, FIG. 15(a) shows an example occupancy of the point neighborhood of FIGS. 14(a) and 14(b) in a motion compensated point cloud. The motion compensated point cloud may be determined, for example, based on a reference point cloud (as described herein) to better match (or be “closer” to) the point cloud of the current edge E in FIGS. 14(a) and 14(b). For example, in FIG. 15(a), among the 16-point locations of the point neighborhood, only 9 locations may be occupied by the motion compensated point cloud. In FIG. 15(a), occupied points are shown for example as filled-in (grey) points and non-occupied points are shown for example as non-filled-in (white) points.

FIG. 15(b) shows another example occupancy of a point neighborhood in a motion compensated point cloud. The motion compensated point cloud may be determined, for example, based on a reference point cloud (as described herein) to better match (or be “closer” to) the point cloud of the current edge E in FIGS. 14(a) and 14(b). The point neighborhood of FIG. 15(b) may comprise the point neighborhood shown in FIGS. 14(a) and 14(b) extended with additional point locations. The quantity of the point locations may comprise a product of an augmented (e.g., extended, prolonged) length of the current edge. For example, the point neighborhood of FIG. 15(b) relative to the current edge E shown in FIGS. 14(a) and 14(b) of length L may comprise 4*(L+2) closest point locations. Of these closest point locations, distance along each coordinate perpendicular to the current edge E may be at most (or no more than) half the minimum distance between point locations, and coordinate along the axis parallel to the current edge E may be contained in a prolonged edge interval. For example, the prolonged edge interval is prolonged by adding the minimum distance between point locations at each end (or extremity) of the edge, to the length L. In FIG. 15(b), among the 24-point locations in the point neighborhood, only 11 locations are occupied by the motion compensated point cloud. In FIG. 15(b), occupied points are shown, for example, as filled-in (grey) points and non-occupied points are shown, for example, as non-filled (white) points.

An encoder and/or a decoder may determine one or more symbols of a neighborhood configuration (e.g., neighborhood configuration β_{TS}) of a current TriSoup edge (e.g., TriSoup edge E). An encoder and/or a decoder may determine one or more symbols of a neighborhood configuration (e.g., neighborhood configuration β_{TS}) of a current TriSoup edge (e.g., TriSoup edge E), for example, based on the occupancies of the points in one of the point neighborhoods of the motion compensated point cloud (e.g., as shown in FIGS. 15(a) and 15(b)). The encoder and/or the decoder may select a context (or probability model) for coding the vertex information of the current TriSoup edge E, for example, based on the neighborhood configuration β_{TS}. The encoder and/or the decoder may select the context for coding the vertex information of the current TriSoup edge E, for example, based on a reduced configuration β_{TS}′=DRⁿ(β_{TS}) representing a subset of the symbols of the neighborhood configuration β_{TS}. The encoder and/or the decoder may select the context, for example, based on an OBUF LUT that maps the neighborhood configuration β_{TS} or the reduced configuration β_{TS}′ to an index of the context. The encoder and/or the decoder may code (e.g., entropy code; e.g., arithmetic code) the vertex information of the current TriSoup edge E, for example, based on the context.

The quantity (or number) of occupied points in a point neighborhood may be excessive (e.g., too large) to be used directly as symbols of a neighborhood configuration (e.g., neighborhood configuration β_{TS}) for coding vertex information of a current edge (e.g., current edge E), for example, even if restraining the point neighborhood of a current edge (e.g., restraining the point neighborhood of current edge E to the point locations shown in FIG. 15(a) or FIG. 15(b). A reduction (e.g., reduction R) of the set of occupancy bits may be used. The reduction (e.g., reduction R) may be obtained, for example, based on the presence of a point of the motion compensated point cloud.

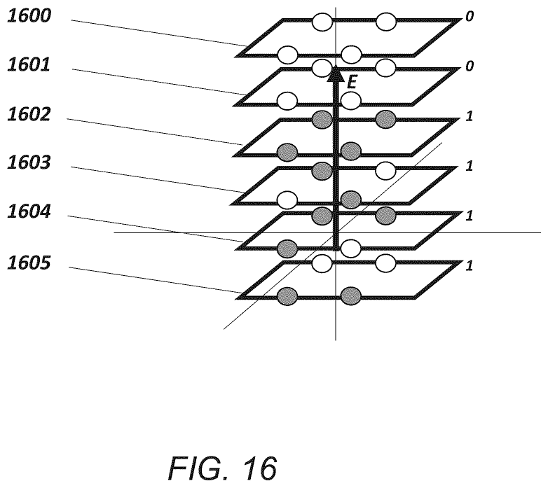

FIG. 16 shows an example of a reduction. More specifically, FIG. 16 shows an example of a reduction (e.g., reduction R) that may be used with respect to a point neighborhood of a current edge E. For example, FIG. 16 shows the reduction (e.g., reduction R) used with respect to the point neighborhood in the example shown in FIG. 15(b). The reduction (e.g., reduction R) may be used/applied for/to other point neighborhoods. As shown in and described with respect to FIG. 16, the reduction (e.g., reduction R) may regroup point locations into a plurality of planes (e.g., planes 1600 to 1605) perpendicular to the current edge E. Each plane may comprise a plurality of point locations. For the example point neighborhood shown in FIG. 16, six planes are defined, each containing four-point locations. The occupancy of a plane may be defined by at least one point location belonging to the plane being occupied by a point of a motion compensated point cloud. For example, the occupancy of a plane may be represented by “1” (occupied) or “0” (unoccupied). For example, in FIG. 16, 24 occupancy bits may be reduced to six (6) plane occupancy bits. For example, the occupancy of the six planes 1600, 1601, 1602, 1603, 1604, and 1605 may be represented by “0”, “0”, “1”, “1”, “1”, and “1”, respectively. Reduction using planes may reduce the number of occupancy bits. Referring to the example described herein with respect to FIG. 15(a), for a current edge having length L, reduction using planes may reduce the number of occupancy bits from 4*L to L. Referring to the example described herein with respect to FIG. 15(b), for a current edge having length L, reduction using planes may reduce the number of occupancy bits from 4*(L+2) to L+2.

An encoder and/or a decoder may determine one or more symbols of a neighborhood configuration (e.g., neighborhood configuration β_{TS}) of a current TriSoup edge (e.g., TriSoup edge E). An encoder and/or a decoder may determine one or more symbols of a neighborhood configuration (e.g., neighborhood configuration β_{TS}) of a current TriSoup edge (e.g., TriSoup edge E), for example, based on plane occupancy bits. The encoder and/or the decoder may select a context (or probability model) for coding vertex information of the current TriSoup edge (e.g., TriSoup edge E), for example, based on the neighborhood configuration (e.g., neighborhood configuration β_{TS}). The encoder and/or the decoder may select the context for coding the vertex information of the current TriSoup edge E, for example, based on a reduced configuration β_{TS}′=DRⁿ(β_{TS}) representing a subset of the symbols of the neighborhood configuration β_{TS}. The encoder and/or the decoder may select the context, for example, based on an OBUF LUT that maps the neighborhood configuration β_{TS} or the reduced configuration β_{TS}′ to an index of the context. The encoder and/or the decoder may code (e.g., entropy code; e.g., arithmetic code) the vertex information of the current TriSoup edge E, for example, based on the context.

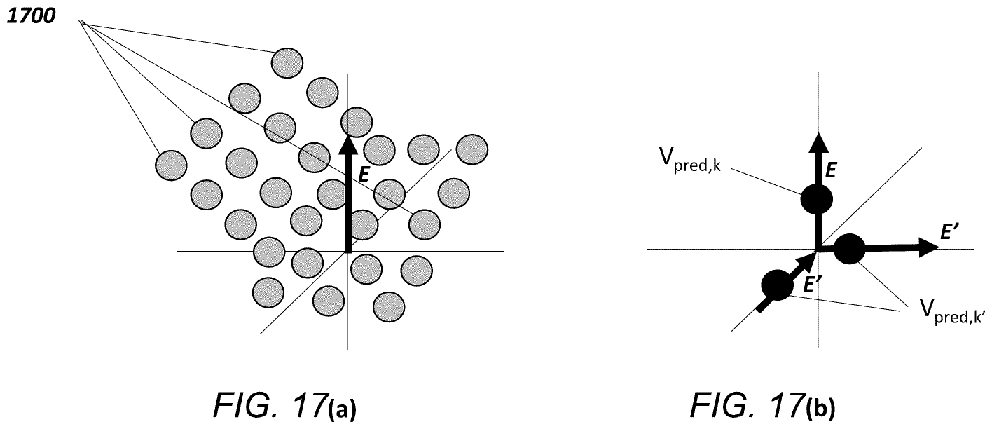

FIG. 17(a) and FIG. 17(b) show another example of a reduction (e.g., reduction R). As described with respect to FIGS. 17(a)-17(b), a compensated TriSoup vertex (e.g., compensated TriSoup vertex V_{pred,k}) may be determined for a current edge (e.g., the current edge E). The compensated TriSoup vertex (e.g., compensated TriSoup vertex V_{pred,k}) may be determined for a current edge (e.g., the current edge E), for example, based on points (e.g., points 1700) of a motion compensated point cloud neighboring the current edge (e.g., the current edge E). The motion compensated point cloud may be determined, for example, based on a reference point cloud (as described herein) to better match (or be “closer” to) the point cloud of a current frame around the current edge (e.g., the current edge E). More compensated TriSoup vertices (e.g., compensated TriSoup vertices V_{pred,k′}) may be determined for neighboring (relative to the current edge) edges (e.g., neighboring edges E′), for example, based on the motion compensated point cloud. Compensated TriSoup vertices may be representative of the intersection of the motion compensated point cloud with the edges. Compensated TriSoup vertices may be determined, for example, based on the points of the motion compensated point cloud in a manner similar to that used for determining TriSoup vertices Vₖ based on the point cloud of the current frame being coded. The method to determine the compensated TriSoup vertices may be the same for both encoding and decoding of the point cloud, for example, to maintain synchronization between encoder and decoder.

An encoder and/or a decoder may determine one or more symbols of a neighborhood configuration (e.g., neighborhood configuration β_{TS}) of a current TriSoup edge (e.g., TriSoup edge E). The encoder and/or a decoder may determine one or more symbols of a neighborhood configuration (e.g., neighborhood configuration β_{TS}) of a current TriSoup edge (e.g., TriSoup edge E), for example, based on information associated with a compensated TriSoup vertex. The information associated with a compensated TriSoup vertex may include, for example, a vertex presence flag (s_{pred,k}) of a compensated TriSoup vertex on an edge. The information associated with a compensated TriSoup vertex may include the vertex presence flag (s_{pred,k}) of a compensated TriSoup vertex on an edge and, if present, the position (p_{pred,k}) of said vertex. The information associated with a compensated TriSoup vertex may be referred to as compensated TriSoup vertex information. The encoder and/or the decoder may select a context (or probability model) for coding the vertex information of the current TriSoup edge (e.g., TriSoup edge E), for example, based on the neighborhood configuration (e.g., neighborhood configuration β_{TS}). For example, the encoder and/or the decoder may select the context for coding the vertex information of the current TriSoup edge E, for example, based on a reduced configuration β_{TS}′=DRⁿ(β_{TS}) representing a subset of the symbols of the neighborhood configuration β_{TS}. The encoder and/or the decoder may select the context, for example, based on an OBUF LUT that maps the neighborhood configuration β_{TS} or the reduced configuration β_{TS}′ to an index of the context. The encoder and/or the decoder may code (e.g., entropy code; e.g., arithmetic code) the vertex information of the current TriSoup edge E, for example, based on the context.

The neighborhood configuration (e.g., neighborhood configuration β_{TS}) may comprise, for example, one bit that is representative of the presence (e.g., presence flag s_{k,pred}) of a compensated TriSoup vertex on the current edge (e.g., current edge E). This example may be advantageous because, if the original point cloud of the current frame and the motion compensated point cloud are close to each other, the two presence flags (e.g., the presence flags sₖ and s_{k,pred}) for the TriSoup vertex and the compensated TriSoup vertex may be highly correlated.

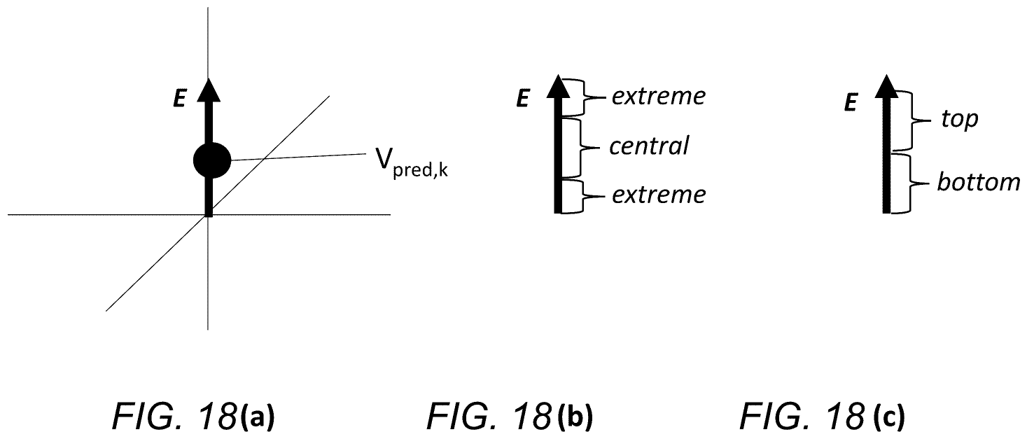

FIG. 18(a) shows an example compensated TriSoup vertex (e.g., compensated TriSoup vertex V_{pred,k}) belonging to an edge (e.g., edge E). FIG. 18(b) and FIG. 18(c) show quantization functions of the position (e.g., position p_{pred,k}) of the compensated TriSoup vertex (e.g., compensated TriSoup vertex V_{pred,k}) belonging to the edge (e.g., edge E). As described with respect to FIG. 18(b), the position (e.g., position p_{pred,k}) may be quantized into two values, for example, “central” and “extreme”. The first value (e.g., “central”) may be representative of the position (e.g., position p_{pred,k}) being far from the start point and far from the end point of the edge. The second value (e.g., “extreme”) may be representative of the position (e.g., position p_{pred,k}) being close to the start point or close to the end point of the edge. For example, “close to” or any synonyms thereof may be understood as having a distance less than one sixth, one fifth, one fourth, or one third of the edge length from the start point or the end point. As another example, “close to” or any synonyms thereof may be understood as having a distance less than a value greater than zero and less than one half of the edge length from the start point or the end point. As yet another example, a neighborhood configuration (e.g., neighborhood configuration β_{TS}), used to select the entropy coder to code the presence flag (e.g., presence flag sₖ) of a vertex on a current edge (e.g., edge E), may contain one bit that is representative of the quantization into the first and second values (e.g., “central” and/or “extreme”) of the position (e.g., position p_{k,pred}) of a compensated TriSoup vertex on the current edge (e.g., edge E). This example may be advantageous because the quantized value (e.g., “central” or “extreme”) may be an indicator of the reliability of the presence flag (e.g., presence flag s_{k,pred}). Correlation between the two presence flags (e.g., presence flags sₖ and s_{k,pred}) for the TriSoup vertex and the compensated TriSoup vertex may be stronger, for example, if the quantized value is the first value (e.g., “central”). The correlation between the two presence flags (e.g., presence flags sₖ and s_{k,pred}) for the TriSoup vertex and the compensated TriSoup vertex may be stronger because an error, relative to the original point cloud, of the motion compensated point cloud may be less likely to change the value of the presence flag (e.g., presence flag s_{k,pred}) compared to the case where the quantized value is the second value (e.g., “extreme”).

As described with respect to FIG. 18(c), the position (e.g., position p_{pred,k}) may be quantized into two values, for example, “bottom” and “top”. The first value (e.g., “bottom”) may be representative of the position (e.g., position p_{pred,k}) being closer to the start point than to the end point of the edge. The second value (e.g., “top”) may be representative of the position (e.g., position p_{pred,k}) being closer to the end point than to the start point of the edge. As another example, a TriSoup neighborhood configuration (e.g., neighborhood configuration β_{TS}), used to select the entropy coder to code the position (e.g., position pₖ) of a vertex on a current edge (e.g., edge E), may contain one bit that is representative of the quantization into the first and second values (e.g., “bottom” and/or “top”) of the position (e.g., position p_{k,pred}) of a compensated TriSoup vertex on the current edge (e.g., edge E). This example may be advantageous because the quantized first value (e.g., “bottom”) may be an indicator of the TriSoup vertex (e.g., vertex Vₖ) being located close to the start point of the edge. On the other hand, the quantized second value (e.g., “top”) may be an indicator of the TriSoup vertex (e.g., vertex Vₖ) being located close to the end point of the edge. The quantized value (e.g., “bottom” or “top”) may be strongly correlated with the highest position bit (e.g., position bit pₖ¹) of the TriSoup vertex position (e.g., position pₖ).

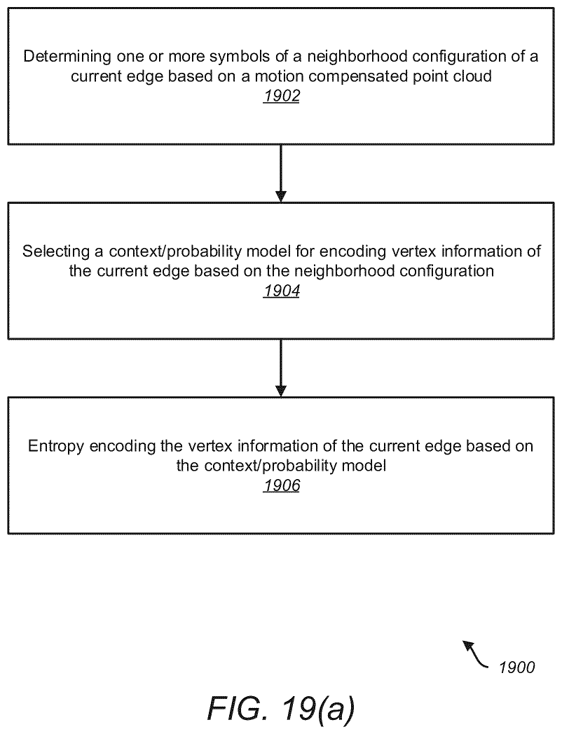

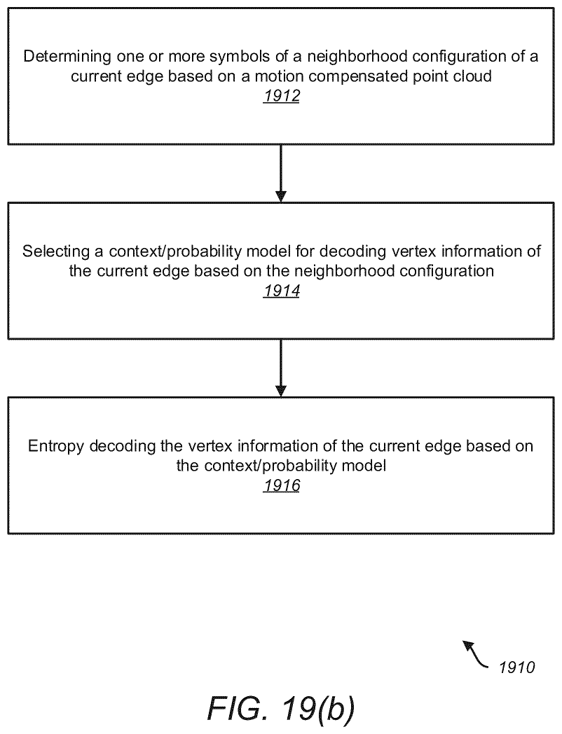

FIG. 19(a) shows an example method for encoding vertex information of a current edge. More specifically, FIG. 19(a) shows a flowchart 1900 of example method steps for encoding vertex information of a current edge. One or more steps of the example flowchart 1900 may be performed by an encoder (e.g., encoder 114 as shown in FIG. 1). FIG. 19(b) shows an example method for decoding vertex information of a current edge. More specifically, FIG. 19(b) shows a flowchart 1910 of example method steps for decoding vertex information of a current edge. One or more steps of the example flowchart 1910 may be performed by a decoder (e.g., decoder 120 as shown in FIG. 1). All or portions of the flowcharts in FIG. 19(a) and FIG. 19(b) may be implemented by a coder (e.g., the encoder 114 in FIG. 1 and/or decoder 120 in FIG. 1), an example computer system 2000 in FIG. 20, and/or an example computing device 2130 in FIG. 21.

Referring to FIG. 19(a), at step 1902, the encoder may determine one or more symbols of a neighborhood configuration of a current edge. One or more symbols of a neighborhood configuration of a current edge may be determined, for example, based on a motion compensated point cloud.

At step 1902, more specifically, the encoder may determine the one or more symbols of a neighborhood configuration of a current edge, for example, based on occupancies of point locations in a motion compensated point cloud. For example, the point locations may each be located from the current edge by a distance, along each coordinate perpendicular to the current edge (e.g., edge E). The distance may be at most (no more than) half the minimum distance between any two point locations. For example, the point locations each may comprise a coordinate along the axis parallel to the current edge. The coordinate may be contained in an edge interval of the current edge. For example, the point locations may comprise 4*L point locations, where L is a length of the current edge. For example, the point locations comprise 4*(L+2) point locations, where L is a length of the current edge.

At step 1902, more specifically, the encoder may determine the one or more symbols of a neighborhood configuration of a current edge, for example, based on a reduction used/applied for/to the occupancies of the point locations. For example, the reduction may comprise determining compensated TriSoup vertex information. For example, the compensated TriSoup vertex information may comprise a vertex presence flag. For example, the compensated TriSoup vertex information may comprise a vertex position. The vertex position may indicate one of two positions between a start point of the current edge and an end point of the current edge, for example, if the compensated TriSoup vertex information comprises a vertex position. For example, the two positions may comprise a central position and an extreme position (e.g., as shown in FIG. 18(b)). As an example, the extreme position may be located on each side of the central position. As another example, the two positions may comprise a top position and a bottom position (e.g., as shown in FIG. 18(c)).

At step 1904, the encoder may select/determine a context/probability model for encoding vertex information of the current edge. A context/probability model for encoding vertex information of the current edge may be selected, for example, based on the neighborhood configuration. The vertex information of the current edge may comprise, for example, a vertex presence flag of the current edge. The vertex information of the current edge may comprise, for example, a vertex position of the current edge. The encoder may select/determine the context/probability model for encoding the vertex information of the current edge, for example, based on a look up table that maps the neighborhood configuration to the context/probability model. The encoder may select/determine the context/probability model for encoding the vertex information of the current edge, for example, based on a look up table that maps only a subset of the symbols of the neighborhood configuration to the context/probability model. For example, a number of symbols in the subset may be increased, for example, based on a number of encoded edges with neighborhood information comprising the same subset of symbols. The encoder may update the look up table to map the subset of symbols of the neighborhood configuration to a different context/probability model, for example, based on the vertex information of the current edge.

At 1906, the encoder may encode (e.g., entropy encode) vertex information of the current edge, for example, based on the context/probability model. For example, the vertex information of the current edge may be arithmetically encoded, for example, based on the context/probability model.

Referring now to FIG. 19(b), at step 1912, the decoder may determine one or more symbols of a neighborhood configuration of a current edge. One or more symbols of a neighborhood configuration of a current edge may be determined, for example, based on a motion compensated point cloud.

At step 1912, more specifically, the decoder may determine the one or more symbols of a neighborhood configuration of a current edge, for example, based on occupancies of point locations in a motion compensated point cloud. For example, the point locations may each be located from the current edge by a distance, along each coordinate perpendicular to the current edge (e.g., edge E). The distance may be at most (no more than) half the minimum distance between any two point locations. For example, the point locations each may comprise a coordinate along the axis parallel to the current edge. The coordinate may be contained in an edge interval of the current edge. For example, the point locations may comprise 4*L point locations, where L is a length of the current edge. For example, the point locations comprise 4*(L+2) point locations, where L is a length of the current edge.

At step 1912, more specifically, the decoder may determine the one or more symbols of a neighborhood configuration of a current edge, for example, based on a reduction used/applied for/to the occupancies of the point locations. For example, the reduction may comprise determining compensated TriSoup vertex information. For example, the compensated TriSoup vertex information may comprise a vertex presence flag. For example, the compensated TriSoup vertex information may comprise a vertex position. The vertex position may indicate one of two positions between a start point of the current edge and an end point of the current edge, for example, if the compensated TriSoup vertex information comprises a vertex position. For example, the two positions may comprise a central position and an extreme position (e.g., as shown in FIG. 18(b)). As an example, the extreme position may be located on each side of the central position. As another example, the two positions may comprise a top position and a bottom position (e.g., as shown in FIG. 18(c)).

At step 1914, the decoder may select/determine a context/probability model for decoding vertex information of the current edge. A context/probability model for decoding vertex information of the current edge may be selected, for example, based on the neighborhood configuration. The vertex information of the current edge may comprise, for example, a vertex presence flag of the current edge. The vertex information of the current edge may comprise, for example, a vertex position of the current edge. The decoder may select/determine the context/probability model for decoding the vertex information of the current edge, for example, based on a look up table that maps the neighborhood configuration to the context/probability model. The decoder may select/determine the context/probability model for decoding the vertex information of the current edge, for example, based on a look up table that maps only a subset of the symbols of the neighborhood configuration to the context/probability model. For example, a number of symbols in the subset may be increased, for example, based on a number of decoded edges with neighborhood information comprising the same subset of symbols. The decoder may update the look up table to map the subset of symbols of the neighborhood configuration to a different context/probability model, for example, based on the vertex information of the current edge.

At 1916, the decoder may decode (e.g., entropy decode) vertex information of the current edge, for example, based on the context/probability model. For example, the vertex information of the current edge may be arithmetically decoded, for example, based on the context/probability model.

FIG. 20 shows an example computer system that may be used by any of the examples described herein. For example, the example computer system 2000 shown in FIG. 20 may implement one or more of the methods described herein. For example, various devices and/or systems described herein (e.g., in FIGS. 1, 2, and 3) may be implemented in the form of one or more computer systems 2000. Furthermore, each of the steps of the flowcharts depicted in this disclosure may be implemented on one or more computer systems 2000.

The computer system 2000 may comprise one or more processors, such as a processor 2004. The processor 2004 may be a special purpose processor, a general purpose processor, a microprocessor, and/or a digital signal processor. The processor 2004 may be connected to a communication infrastructure 2002 (for example, a bus or network). The computer system 2000 may also comprise a main memory 2006 (e.g., a random access memory (RAM)), and/or a secondary memory 2008.

The secondary memory 2008 may comprise a hard disk drive 2010 and/or a removable storage drive 2012 (e.g., a magnetic tape drive, an optical disk drive, and/or the like). The removable storage drive 2012 may read from and/or write to a removable storage unit 2016. The removable storage unit 2016 may comprise a magnetic tape, optical disk, and/or the like. The removable storage unit 2016 may be read by and/or may be written to the removable storage drive 2012. The removable storage unit 2016 may comprise a computer usable storage medium having stored therein computer software and/or data.

The secondary memory 2008 may comprise other similar means for allowing computer programs or other instructions to be loaded into the computer system 2000. Such means may include a removable storage unit 2018 and/or an interface 2014. Examples of such means may comprise a program cartridge and/or cartridge interface (such as in video game devices), a removable memory chip (such as an erasable programmable read-only memory (EPROM) or a programmable read-only memory (PROM)) and associated socket, a thumb drive and USB port, and/or other removable storage units 2018 and interfaces 2014 which may allow software and/or data to be transferred from the removable storage unit 2018 to the computer system 2000.

The computer system 2000 may also comprise a communications interface 2020. The communications interface 2020 may allow software and data to be transferred between the computer system 2000 and external devices. Examples of the communications interface 2020 may include a modem, a network interface (e.g., an Ethernet card), a communications port, etc. Software and/or data transferred via the communications interface 2020 may be in the form of signals which may be electronic, electromagnetic, optical, and/or other signals capable of being received by the communications interface 2020. The signals may be provided to the communications interface 2020 via a communications path 2022. The communications path 2022 may carry signals and may be implemented using wire or cable, fiber optics, a phone line, a cellular phone link, an RF link, and/or any other communications channel(s).

A computer program medium and/or a computer readable medium may be used to refer to tangible storage media, such as removable storage units 2016 and 2018 or a hard disk installed in the hard disk drive 2010. The computer program products may be means for providing software to the computer system 2000. The computer programs (which may also be called computer control logic) may be stored in the main memory 2006 and/or the secondary memory 2008. The computer programs may be received via the communications interface 2020. Such computer programs, when executed, may enable the computer system 2000 to implement the present disclosure as discussed herein. In particular, the computer programs, when executed, may enable the processor 2004 to implement the processes of the present disclosure, such as any of the methods described herein. Accordingly, such computer programs may represent controllers of the computer system 2000.

FIG. 21 shows example elements of a computing device that may be used to implement any of the various devices described herein, including, for example, a source device (e.g., 102), an encoder (e.g., 200), a destination device (e.g., 106), a decoder (e.g., 300), and/or any computing device described herein. The computing device 2130 may include one or more processors 2131, which may execute instructions stored in the random-access memory (RAM) 2133, the removable media 2134 (such as a Universal Serial Bus (USB) drive, compact disk (CD) or digital versatile disk (DVD), or floppy disk drive), or any other desired storage medium. Instructions may also be stored in an attached (or internal) hard drive 2135. The computing device 2130 may also include a security processor (not shown), which may execute instructions of one or more computer programs to monitor the processes executing on the processor 2131 and any process that requests access to any hardware and/or software components of the computing device 2130 (e.g., ROM 2132, RAM 2133, the removable media 2134, the hard drive 2135, the device controller 2137, a network interface 2139, a GPS 2141, a Bluetooth interface 2142, a WiFi interface 2143, etc.). The computing device 2130 may include one or more output devices, such as the display 2136 (e.g., a screen, a display device, a monitor, a television, etc.), and may include one or more output device controllers 2137, such as a video processor. There may also be one or more user input devices 2138, such as a remote control, keyboard, mouse, touch screen, microphone, etc. The computing device 2130 may also include one or more network interfaces, such as a network interface 2139, which may be a wired interface, a wireless interface, or a combination of the two. The network interface 2139 may provide an interface for the computing device 2130 to communicate with a network 2140 (e.g., a RAN, or any other network). The network interface 2139 may include a modem (e.g., a cable modem), and the external network 2140 may include communication links, an external network, an in-home network, a provider's wireless, coaxial, fiber, or hybrid fiber/coaxial distribution system (e.g., a DOCSIS network), or any other desired network. Additionally, the computing device 2130 may include a location-detecting device, such as a global positioning system (GPS) microprocessor 2141, which may be configured to receive and process global positioning signals and determine, with possible assistance from an external server and antenna, a geographic position of the computing device 2130.

The example in FIG. 21 may be a hardware configuration, although the components shown may be implemented as software as well. Modifications may be made to add, remove, combine, divide, etc. components of the computing device 2130 as desired. Additionally, the components may be implemented using basic computing devices and components, and the same components (e.g., processor 2131, ROM storage 2132, display 2136, etc.) may be used to implement any of the other computing devices and components described herein. For example, the various components described herein may be implemented using computing devices having components such as a processor executing computer-executable instructions stored on a computer-readable medium, as shown in FIG. 21. Some or all of the entities described herein may be software based, and may co-exist in a common physical platform (e.g., a requesting entity may be a separate software process and program from a dependent entity, both of which may be executed as software on a common computing device).

Hereinafter, various characteristics will be highlighted in a set of paragraphs. These characteristics are not to be interpreted as being limiting on the invention or inventive concept, but are provided merely as a highlighting of some characteristics as described herein, without suggesting a particular order of importance or relevancy of such characteristics.

A computing device may perform a method comprising multiple operations. The computing device may determine, based on a motion compensated point cloud, one or more symbols of a neighborhood configuration of a current edge associated with a video frame or a point cloud frame. The computing device may select, based on the neighborhood configuration, a context for coding (e.g., encoding or decoding) vertex information of the current edge. Based on the context, the computing device may code (e.g., encode or decode) the vertex information of the current edge. Based on occupancies of point locations in the motion compensated point cloud, the computing device may determine the one or more symbols of the neighborhood configuration. Based on a reduction of occupancies of point locations in the motion compensated point cloud, the computing device may determine the one or more symbols of the neighborhood configuration. The computing device may determine compensated vertex information of the current edge. The vertex information may comprise at least one of: a vertex presence flag; or a vertex position. The computing device may select the context based on an association between the neighborhood configuration and the context. The computing device may select the context based on an association between a subset of the one or more symbols of the neighborhood configuration and the context. Based on the vertex information of the current edge, the computing device may update an association between a subset of the one or more symbols of the neighborhood configuration and a different context. The motion compensated point cloud may comprise point locations. A quantity of the point locations may comprise a product of a length of the current edge. The motion compensated point cloud may comprise point locations. A quantity of the point locations may comprise a product of an augmented length of the current edge. The vertex information may comprise a vertex position. The vertex position may indicate one of two positions comprising a central position and an extreme position. The vertex information may comprise a vertex position. The vertex position may indicate one of two positions comprising a top position and a bottom position. The computing device may comprise one or more processors; and memory storing instructions that, when executed by the one or more processors, cause the computing device to perform the described method, additional operations and/or include the additional elements. A system may comprise a first computing device configured to perform the described method, additional operations and/or include the additional elements; and a second computing device configured to code (e.g., encode or decode) a video frame, a point cloud frame, or a point cloud sequence. A computer-readable medium may store instructions that, when executed, cause performance of the described method, additional operations and/or include the additional elements.

A computing device may perform a method comprising multiple operations. The computing device may determine one or more symbols of a neighborhood configuration of a current edge associated with a video frame or a point cloud frame, based on occupancies of point locations in a motion compensated point cloud. The computing device may select a context based on the neighborhood configuration and an association between the neighborhood configuration and the context. Based on the selected context, the computing device may code (e.g., encode or decode) vertex information of the current edge. Each of the point locations may be located from the current edge by a distance and in a direction perpendicular to the current edge. The distance may be no more than half a minimum distance between any two point locations. Each of the point locations may comprise a coordinate along an axis parallel to the current edge. The coordinates may be contained in an edge interval of the current edge. A quantity of the point locations may comprise a product of a length of the current edge. A quantity of the point locations may comprise a product of an augmented length of the current edge. Based on a reduction of occupancies of point locations in the motion compensated point cloud, the computing device may determine the one or more symbols of the neighborhood configuration. Based on the vertex information of the current edge, the computing device may determine an association between a subset of the one or more symbols of the neighborhood configuration and a different context. The computing device may comprise one or more processors; and memory storing instructions that, when executed by the one or more processors, cause the computing device to perform the described method, additional operations and/or include the additional elements. A system may comprise a first computing device configured to perform the described method, additional operations and/or include the additional elements; and a second computing device configured to code (e.g., encode or decode) a video frame, a point cloud frame, or a point cloud sequence. A computer-readable medium may store instructions that, when executed, cause performance of the described method, additional operations and/or include the additional elements.

A computing device may perform a method comprising multiple operations. The computing device may determine, based on a reduction of occupancies of point locations in a motion compensated point cloud, one or more symbols of a neighborhood configuration of a current edge associated with a video frame or a point cloud frame. The computing device may, based on the neighborhood configuration, select a context for coding (e.g., encoding or decoding) vertex information of the current edge. The vertex information may comprise a vertex presence flag and a vertex position. Based on the context, the computing device may code (e.g., encode or decode) the vertex information of the current edge. The vertex position may indicate one of two positions between a start point of the current edge and an end point of the current edge. The vertex position may indicate one of two positions comprising a central position and an extreme position. The vertex position may indicate one of two positions comprising a top position and a bottom position. The determining, selecting, and coding (e.g., entropy coding) may be performed by a decoder. The computing device may comprise one or more processors; and memory storing instructions that, when executed by the one or more processors, cause the computing device to perform the described method, additional operations and/or include the additional elements. A system may comprise a first computing device configured to perform the described method, additional operations and/or include the additional elements; and a second computing device configured to code (e.g., encode or decode) a video frame, a point cloud frame, or a point cloud sequence. A computer-readable medium may store instructions that, when executed, cause performance of the described method, additional operations and/or include the additional elements.

A computing device may perform a method comprising multiple operations. The computing device may determine one or more symbols of a neighborhood configuration of a current edge associated with a video frame or a point cloud frame, based on a motion compensated point cloud. The computing device may select, based on the neighborhood configuration, a context/probability model for coding (e.g., encoding or decoding) vertex information of the current edge. The computing device may code (e.g., entropy code) the vertex information of the current edge based on the context/probability model. The computing device may determine the one or more symbols of the neighborhood configuration based on occupancies of point locations in the motion compensated point cloud. The point locations may be each located from the current edge by a distance, along each coordinate perpendicular to the current edge E, that may be at most half the minimum distance between any two point locations. The point locations each may comprise a coordinate along the axis parallel to the current edge that may be contained in an edge interval of the current edge. The point locations may comprise 4*L point locations, where L is a length of the current edge. The point locations may comprise 4*(L+2) point locations, where L is a length of the current edge. The computing device may determine the one or more symbols of the neighborhood configuration based on a reduction applied to the occupancies of the point locations. The reduction may comprise determining compensated TriSoup vertex information. The compensated TriSoup vertex information may comprise a vertex presence flag. The compensated TriSoup vertex information may comprise a vertex position. The vertex position may indicate one of two positions between a start point of the current edge and an end point of the current edge. The two positions may comprise a central position and an extreme position. The two positions may comprise a top position and a bottom position. The vertex information of the current edge may comprise a vertex presence flag of the current edge. The vertex information of the current edge may comprise a vertex position of the current edge. The computing device may select the context/probability model for coding (e.g., encoding or decoding) the vertex information of the current edge based on a look up table that maps the neighborhood configuration to the context/probability model. The computing device may select the context/probability model for coding (e.g., encoding or decoding) the vertex information of the current edge based on a look up table that maps only a subset of the symbols of the neighborhood configuration to the context/probability model. A number of symbols in the subset may be increased based on a number of coded edges with neighborhood information comprising the same subset of symbols. The computing device may update the look up table to map the subset of symbols of the neighborhood configuration to a different context/probability model based on the vertex information of the current edge. The computing device may comprise one or more processors; and memory storing instructions that, when executed by the one or more processors, cause the computing device to perform the described method, additional operations and/or include the additional elements. A system may comprise a first computing device configured to perform the described method, additional operations and/or include the additional elements; and a second computing device configured to code (e.g., encode or decode) a video frame, a point cloud frame, or a point cloud sequence. A computer-readable medium may store instructions that, when executed, cause performance of the described method, additional operations and/or include the additional elements.

One or more examples herein may be described as a process which may be depicted as a flowchart, a flow diagram, a data flow diagram, a structure diagram, and/or a block diagram. Although a flowchart may describe operations as a sequential process, one or more of the operations may be performed in parallel or concurrently. The order of the operations shown may be re-arranged. A process may be terminated when its operations are completed, but could have additional steps not shown in a figure. A process may correspond to a method, a function, a procedure, a subroutine, a subprogram, etc. If a process corresponds to a function, its termination may correspond to a return of the function to the calling function or the main function.

Operations described herein may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks. Features of the disclosure may be implemented in hardware using, for example, hardware components such as application-specific integrated circuits (ASICs) and gate arrays. Implementation of a hardware state machine to perform the functions described herein will also be apparent to persons skilled in the art.

One or more features described herein may be implemented in a computer-usable data and/or computer-executable instructions, such as in one or more program modules, executed by one or more computers or other devices. Generally, program modules include routines, programs, objects, components, data structures, etc. that perform particular tasks or implement particular abstract data types when executed by a processor in a computer or other data processing device. The computer executable instructions may be stored on one or more computer readable media such as a hard disk, optical disk, removable storage media, solid state memory, RAM, etc. The functionality of the program modules may be combined or distributed as desired. The functionality may be implemented in whole or in part in firmware or hardware equivalents such as integrated circuits, field programmable gate arrays (FPGA), and the like. Particular data structures may be used to more effectively implement one or more features described herein, and such data structures are contemplated within the scope of computer executable instructions and computer-usable data described herein. Computer-readable medium may comprise, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

A non-transitory tangible computer readable media may comprise instructions executable by one or more processors configured to cause operations described herein. An article of manufacture may comprise a non-transitory tangible computer readable machine-accessible medium having instructions encoded thereon for enabling programmable hardware to cause a device (e.g., an encoder, a decoder, a transmitter, a receiver, and the like) to allow operations described herein. The device, or one or more devices such as in a system, may include one or more processors, memory, interfaces, and/or the like.

Communications described herein may be determined, generated, sent, and/or received using any quantity of messages, information elements, fields, parameters, values, indications, information, bits, and/or the like. While one or more examples may be described herein using any of the terms/phrases message, information element, field, parameter, value, indication, information, bit(s), and/or the like, one skilled in the art understands that such communications may be performed using any one or more of these terms, including other such terms. For example, one or more parameters, fields, and/or information elements (IEs), may comprise one or more information objects, values, and/or any other information. An information object may comprise one or more other objects. At least some (or all) parameters, fields, IEs, and/or the like may be used and can be interchangeable depending on the context. If a meaning or definition is given, such meaning or definition controls.

One or more elements in examples described herein may be implemented as modules. A module may be an element that performs a defined function and/or that has a defined interface to other elements. The modules may be implemented in hardware, software in combination with hardware, firmware, wetware (e.g., hardware with a biological element) or a combination thereof, all of which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. Additionally or alternatively, it may be possible to implement modules using physical hardware that incorporates discrete or programmable analog, digital and/or quantum hardware. Examples of programmable hardware may comprise: computers, microcontrollers, microprocessors, application-specific integrated circuits (ASICs); field programmable gate arrays (FPGAs); and/or complex programmable logic devices (CPLDs). Computers, microcontrollers and/or microprocessors may be programmed using languages such as assembly, C, C++ or the like. FPGAs, ASICs and CPLDs are often programmed using hardware description languages (HDL), such as VHSIC hardware description language (VHDL) or Verilog, which may configure connections between internal hardware modules with lesser functionality on a programmable device. The above-mentioned technologies may be used in combination to achieve the result of a functional module.

One or more of the operations described herein may be conditional. For example, one or more operations may be performed if certain criteria are met, such as in computing device, a communication device, an encoder, a decoder, a network, a combination of the above, and/or the like. Example criteria may be based on one or more conditions such as device configurations, traffic load, initial system set up, packet sizes, traffic characteristics, a combination of the above, and/or the like. If the one or more criteria are met, various examples may be used. It may be possible to implement any portion of the examples described herein in any order and based on any condition.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the descriptions herein. Accordingly, the foregoing description is by way of example only, and is not limiting.

1. A method comprising:
determining, based on a motion compensated point cloud, one or more symbols of a neighborhood configuration of a current edge associated with a video frame;
selecting, based on the neighborhood configuration, a context for coding vertex information of the current edge; and
based on the context, decoding the vertex information of the current edge.

2. The method of claim 1, wherein the determining further comprises:
based on occupancies of point locations in the motion compensated point cloud, determining the one or more symbols of the neighborhood configuration.

3. The method of claim 1, wherein the determining further comprises:
based on a reduction of occupancies of point locations in the motion compensated point cloud, determining the one or more symbols of the neighborhood configuration.

4. The method of claim 1, wherein the determining further comprises:
determining compensated vertex information of the current edge.

5. The method of claim 4, wherein the vertex information comprises at least one of:
a vertex presence flag; or
a vertex position.

6. The method of claim 1, wherein the selecting further comprises:
selecting the context based on an association between the neighborhood configuration and the context.

7. The method of claim 1, wherein the selecting further comprises:
selecting the context based on an association between a subset of the one or more symbols of the neighborhood configuration and the context.

8. The method of claim 1, further comprising:
based on the vertex information of the current edge, updating an association between a subset of the one or more symbols of the neighborhood configuration and a different context.

9. A method comprising:
based on occupancies of point locations in a motion compensated point cloud, determining one or more symbols of a neighborhood configuration of a current edge associated with a video frame;
selecting a context based on the neighborhood configuration and an association between the neighborhood configuration and the context; and
based on the selected context, decoding vertex information of the current edge.

10. The method of claim 9, wherein each of the point locations are located from the current edge by a distance and in a direction perpendicular to the current edge, wherein the distance is no more than half a minimum distance between any two point locations.

11. The method of claim 9, wherein each of the point locations comprise a coordinate along an axis parallel to the current edge, and wherein the coordinates are contained in an edge interval of the current edge.

12. The method of claim 9, wherein a quantity of the point locations comprises a product of a length of the current edge.

13. The method of claim 9, wherein a quantity of the point locations comprises a product of an augmented length of the current edge.

14. The method of claim 9, wherein the determining further comprises:
based on a reduction of occupancies of point locations in the motion compensated point cloud, determining the one or more symbols of the neighborhood configuration.

15. The method of claim 9, further comprising:
based on the vertex information of the current edge, determining an association between a subset of the one or more symbols of the neighborhood configuration and a different context.

16. A method comprising:
determining, based on a reduction of occupancies of point locations in a motion compensated point cloud, one or more symbols of a neighborhood configuration of a current edge associated with a video frame;
based on the neighborhood configuration, selecting a context for coding vertex information, of the current edge, comprising a vertex presence flag and a vertex position; and
based on the context, coding the vertex information of the current edge.

17. The method of claim 16, wherein the vertex position indicates one of two positions between a start point of the current edge and an end point of the current edge.

18. The method of claim 16, wherein the vertex position indicates one of two positions comprising a central position and an extreme position.

19. The method of claim 16, wherein the vertex position indicates one of two positions comprising a top position and a bottom position.

20. The method of claim 16, wherein the determining, selecting, and coding are performed by a decoder.
